(19) United States
(12) Patent Application Publication
(10) Pub. No.: US 2022/0215775 A1
(43) Pub. Date: Jul. 7, 2022

(54) HARDWARE SOFTWARE COMPLEX FOR LANGUAGE TEACHING WITH AD SUPPORT

(71) Applicants: Micah Kosstrin-Greenberg, Stamford, CT (US); Ofir Geller, Yavniel (IL)

(72) Inventors: Micah Kosstrin-Greenberg, Stamford, CT (US); Ofir Geller, Yavniel (IL)

(21) Appl. No.: 17/704,993

(22) Filed: Mar. 25, 2022

Related U.S. Application Data
(63) Continuation-in-part of application No. 15/372,364, filed on Dec. 7, 2016.
Application No. 15/372,364 is a continuation-in-part of application No. 14/813,490, filed on Jul. 30, 2015, now Pat. No. 10,854,106.
(60) Provisional application No. 62/031,127, filed on Jul. 30, 2014.

(51) Int. Cl. G09B 19/06; G06N 20/00; G06Q 30/02; G09B 7/04; G09B 7/08

(52) U.S. Cl. CPC G09B 19/06; G06N 20/00; G09B 7/08; G09B 7/04; G06Q 30/0273

(57) ABSTRACT

A network of purpose-specialized servers, databases, high-speed media delivery clusters and client systems making up a language learning system uses software-ordered methods to teach foreign language, allowing for a novel method of in-line advertising to support unpaid access by students. Reinforcements present practice problems for typed translation, multiple choice or spoken response. Advertisers can sponsor a practice problem by replacing a word in a practice problem with the advertiser's brand, product term, audio message, image or video. The advertiser's branding is seen, heard, typed and spoken by the student in appropriate language contexts and without distracting from language learning.

### CLAIM OF PRIORITY BENEFIT

This application claims the benefit of USPTO Provisional Application No. 62/264,213, filed 7 Dec. 2015. This application also claims the benefit of U.S. patent Ser. No. 10/854,106B2, filed as USPTO Utility application Ser. No. 14/813,490, filed 30 Jul. 2015. This application is a continuation-in-part of USPTO Utility application Ser. No. 15/372,364, filed 7 Dec. 2016.

### FIELD OF THE INVENTION

The invention relates a language teaching and advertising system. More particularly, the present invention relates a network, hardware architecture and system for presenting adaptive advertising in a personalized teaching system.

### BACKGROUND INFORMATION

Human learning requires the introduction of new material while practicing old material. A person's ability to self-regulate this process is limited, as it is difficult for a student of languages to estimate the degree of familiarity he has with a single word or grammatical rule in a given set of such words and rules. It is also difficult to determine whether or not enough time has passed since the last exposure to a given word or rule to merit practicing it again.

Some computer-aided language learning methods have employed a concept called ‘space repetition’ to address the second of the above issues. Alternative names include ‘spaced rehearsal’, ‘expanding rehearsal’, ‘graduated intervals’, ‘repetition spacing’, ‘repetition scheduling’, ‘spaced retrieval’ and ‘expanded retrieval’.

Typically, the learned material consists of pairs of two items, where the learner is memorizing the connection between the two items. For instance, a student may be asked to provide the correct translation of a word or sentence into a target language. After the first exposure to this bit of learning material, when it is the time to review the item again the learner is shown one of the two items and is asked to produce or select from a list the connected item. If he does so successfully, the time or ‘spacing’ until the next repetition will increase. If he fails, the time until the next repetition will decrease.

More sophisticated systems make use of additional techniques. Learning speed is improved when words and rules are practiced together as parts of a sentence, rather than piecemeal. Language learning via repeated exposure to a word or rule is enhanced if the word or rule is practiced in an authentic context, placing it in a sentence alongside related items and concepts. And, a student's learning is enhanced when he already has familiarity with concepts that are practiced together.

An unsolved issue in targeted learning systems is payment. For example, a computer-based language learning system could be purchased by an individual user, or paid for by a school's teaching department and presented to students as part of a course. However, other users of such a system may prefer not to pay to use it. For these users, an advertising driven approach may be preferable.

Interspersing advertising with television shows or internet search results is well-known, but that sort of approach can be disruptive. What is sought is a method of creating, selling and presenting advertising within traditional, adaptive or uncategorized language learning systems that does not interrupt the learning enhancement methods of various language learning systems.

### SUMMARY

A computer-based language learning system uses practice problems to drill a student in translation. Some practice problems function as advertising and are structured so as to include at intervals a sponsor's name or product as a word in a practice problem.

The computer-aided language learning system includes database entries of practice problems. Student responses to sentence practice can thus be used to track the student's translation facility. The database of practice problems also includes sponsored practice problems. Sponsored practice problems are formed by editing an existing practice problem to include an advertiser's brand, product or concept as text, audio, video, image, VR or other appropriate communication means. Sponsorable practice problems are designated by the language learning system, with the editable word or words in the sentence indicated by the sponsor's interface. Where a practice problem suitable for editing to include the sponsor's message is not available, administrators of the language system can create one for the sponsor.

Users of the sponsored version of the enhanced language learning system see, hear, type and speak the sponsor's message without interrupting immersion, targeted repetition or other learning enhancements.

Learning records for each practice sentence may track how many times it has been seen, how recently it was seen, how many times it has been responded to correctly, the problem's difficulty and a repetition interval based on prior incorrect answers. Sponsors can look at these tracked pieces of information in the learning records for sponsored practice problems in order to assess their impact. Data in such learning records, as well as data associated with need-to-practice referred to below, may also be referred to as items of language learning data for the purposes of this application.

More nuanced systems may also include learning records for rule-items, such as individual words and sentence-governing rules. This allows the nuanced language learning system to determine the aspects of the rule-item of which a student lacks mastery. Thus, in addition to increasing the frequency with which a student is presented with practice sentences containing a rule-item he has previously had trouble with, the nuanced language learning system is able to provided targeted reinforcement by drilling the student on the particular aspect of the rule-item needing practice, in proximity to a practice problem using the rule-item.

Practice sentences in such a nuanced system are selected for student translation using an aggregated ‘need-to-practice’ value based on the need-to-practice ratings of each of the rule-items making up the practice sentence. Practice sentences are shown to the student if they are made up of known rule-items. Sponsored rule-items have their own ‘need-to-practice’ ratings and sponsored practice sentences may be selected using separate criteria from non-sponsored practice problems.

Depending on the specifics of the language learning system, students may hear or see a sponsored or non-sponsored practice problem, and may respond to it by typing a translation, making a multiple choice answer, or speaking an answer. That is, the practice problem may be presented in the student's first language for translation into the language he is learning, or vice versa. The sentence may be presented in typed format or audio format. It may require answer in by typing or recorded speaking.

Other methods and structures are described in the detailed description below. This summary does not purport to define the invention. The invention is defined by the claims.

### BRIEF DESCRIPTION OF THE DRAWINGS

FIG. 1 (PRIOR ART) is a flowchart illustrating the operation of a language learning system using spaced repetition in the prior art.

FIG. 2 (PRIOR ART) illustrates a simple sentence translation practice problem in the prior art.

FIG. 3 (PRIOR ART) illustrates a simple multiple choice practice problem in the prior art.

FIG. 4 is a diagram portraying an overview of hardware and software relationships in the preferred embodiment of the invention

FIG. 5 depicts a more detailed diagram of the language module.

FIG. 6 illustrates a sponsorable sentence translation practice problem as seen via the sponsor's interface.

FIG. 7 illustrates a sponsorable multiple choice practice problem as seen via the sponsor's interface.

FIG. 8 illustrates a sponsorable arithmetic word problem as seen via the sponsor's interface.

FIG. 9 illustrates using a keyword search to browse sponsorable practice problems in the sponsor's interface.

FIG. 10 is a flowchart indicating how a sponsor locates a practice problem to sponsor by logging in to the language learning system and working through practice problems as a user.

FIG. 11 is a flowchart indicating how a sponsor locates a practice problem to sponsor by logging in to the language learning system and running a keyword search.

FIG. 12 is a flowchart illustrating a variation of FIG. 10 that can be used in language learning systems that have translatable sentences or other practice problems composed of word rule-items, sentence governing rule-items, or other modular concepts used to compose a sentence

FIG. 13 depicts a more detailed diagram of the ad hardware cluster.

FIG. 14 depicts a system architecture with a high-speed bus and caching.

FIG. 15 depicts a more detailed view of ad BLOB server groupings of an ad hardware cluster.

FIG. 16 illustrates a sponsored sentence translation practice problem as presented to a student of a language learning system.

FIG. 17 illustrates a sponsored multiple choice practice problem as presented to a student of a language learning system.

FIG. 18 is a diagram representing three example sentence translations that have been edited to include sponsor terms.

FIG. 19 is a diagram representing two example sentence translations that have undergone more complex editing to include sponsor terms.

FIG. 20 is a flowchart indicating a first method of selecting, presenting and showing feedback for a sponsored practice problem according to the invention.

FIG. 21 is a variant of the flowchart of FIG. 20, indicating an alternate method of selecting, presenting and showing feedback for a sponsored practice problem according to the invention.

FIG. 22 is a flowchart indicating an alternate method of selecting, presenting and showing feedback for a sponsored practice problem according to the invention.

### DETAILED DESCRIPTION

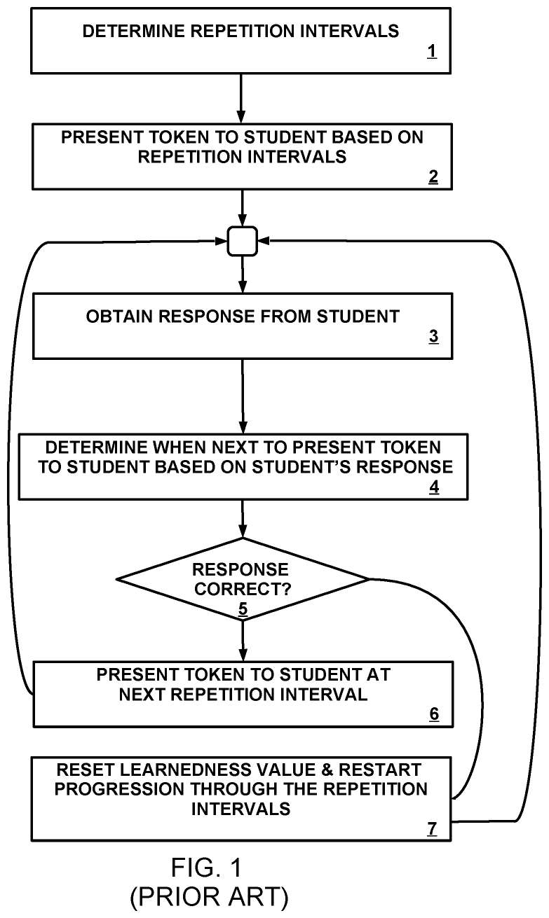

FIG. 1 (PRIOR ART) is a flowchart illustrating the operation of language learning system using spaced repetition in the prior art. In step 1, how large of an interval to leave between repetitions of a language quiz with a binary ‘right’ or ‘wrong’ answer is determined. In step 2, a language quiz item or ‘token’ is presented to a student. In step 3, a response to the token is obtained from a student, and in step 4 the method enters a routine for altering the interval between now and the next presentation of the same token. At step 5, a correct by the student flows to step 6, in which the interval is not altered from its current state, and then loops back to the next question. An incorrect answer at step 5 sends the flow to step 7, in which the interval for repeating the question is shortened because it requires practice more frequently.

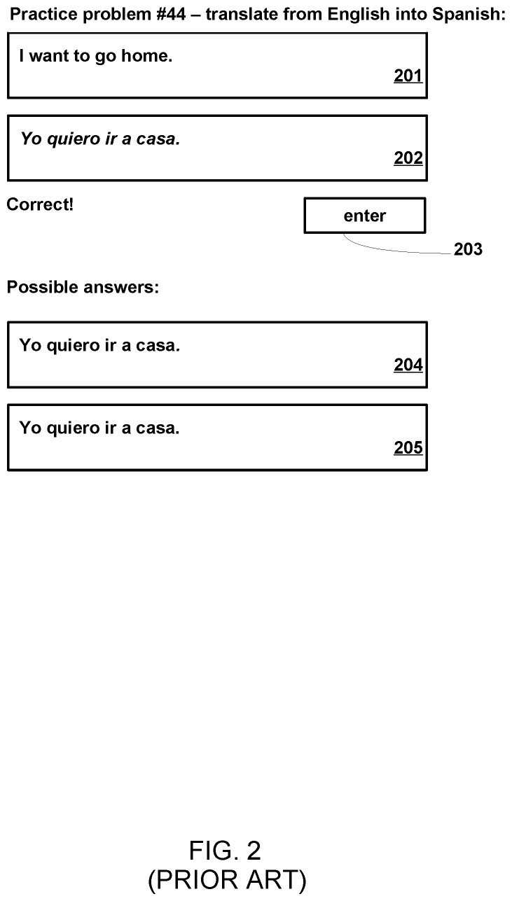

FIG. 2 (PRIOR ART) illustrates a simple sentence translation practice problem in the prior art. First, the student is shown a sentence to translate, either from a known language into the studied language, or vice versa. In this example 201, the English sentence “I want to go home is” presented for translation. In section 202 is a space for the student to type a correct translation of the sentence from part 201. In this case, the student types the correct translation “Yo quiero it a casa” and presses an “enter” button 203. The system determines that this is a correct response, according to step 105 of FIG. 1, above. Possible correct response are shown to the student as feedback as “Yo quiero ir a casa” 204 and “Quiero ir a casa” 205.

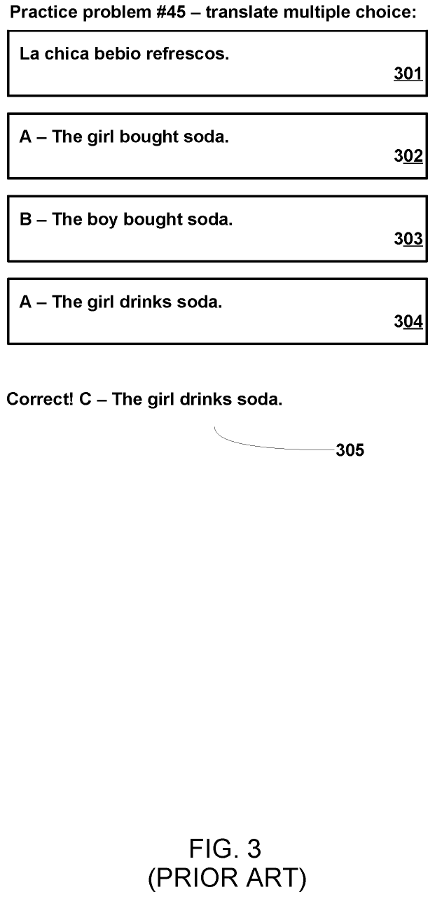

FIG. 3 (PRIOR ART) illustrates a simple multiple choice practice problem in the prior art. First, the student is shown a sentence to translate, either from a known language into the studied language, or vice versa. At section 301, the student in this example is shown the Spanish sentence “La chica bebi6 refrescos”. In section 302, the student is presented a first of multiple choices for translating the sentence as “The girl bought soda”. In section 303, the user is presented a second of multiple choices for translating the sentence as “The boy wants soda”. In section 304, the user is presented the third and correct one of multiple choices for translating the sentence as “The girl drinks soda”. At 305, the system provides the student feedback, confirming that the student's choice of item “C—The girl drinks soda” is correct.

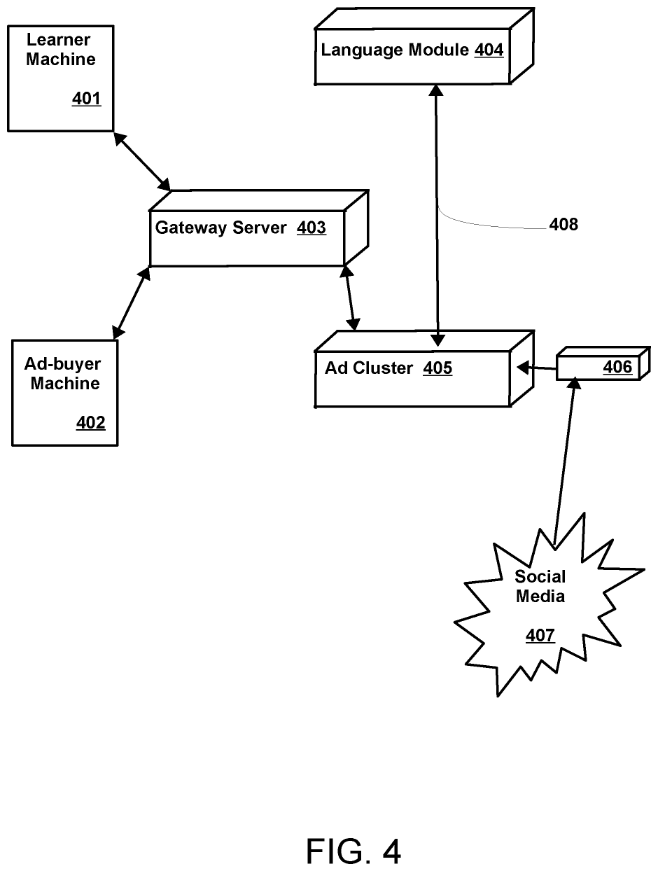

FIG. 4 is a diagram portraying an overview of hardware and software relationships in the preferred embodiment of the invention. These hardware and software relationships enable delivery of language reinforcements with media to large numbers of simultaneous language learners. More, these hardware and software relationships enable targeted advertising in the form of text, audio, video and image ads directed into language reinforcements, in situ, to large numbers of simultaneous language learners.

What is disclosed is a network, hardware architecture and system of presenting to a student sponsored portions of a course of language study. The computer-aided language learning system of the invention is networked, allowing a language learner to receive new practice problems, audio translation files and other language reinforcements by download as they are added to the system. At least one hardware element of the network of the language learning system includes at least one non-volatile data store, also called a non-volatile memory, storing information regarding a plurality of language practice problems. The hardware element storing information regarding language practice problems can be referred to as a language text data server.

At least one hardware element of the network of the language learning system includes one or more processors in communication with this language practice problem non-volatile memory either as part of the language text data server, or else over a network as part of a separate network server device. This number of processors is also connected to one or more non-volatile software instruction memories within elements of the language learning system hardware network. Said non-volatile software instruction memories store computer-executable instructions that cause, when executed by the processors, the language teaching and sponsoring activities described herein. Memory, processor, network server, and other hardware elements are described in the singular or plural where grammatically sensible, and can be embodied singly or in multiple.

The language learner is also able to upload and return responses to language reinforcements via this hardware and software network, such that the course of his language training may be guided via determinations of his language familiarity in other parts of the network as described here and in the parent applications. The learner machine 401 can be any machine utilized by the learner to connect with the language learning system network. Learner machines are network-capable devices running client-side interfaces to the language learning network of the invention such as personal computers and laptops, tablets, PDAs, smart phones, electronic books, televisions, set top devices and the like. Since the language learning system delivers, records and receives audio translations of language, such learner machines are expected to have microphone and speaker (or headphone) capacity either built-in or added as a peripheral device.

Though it may have an off-line mode, the learner machine 401 connects to the language learning hardware and software over a network. This network is typically the internet. In the preferred embodiment of the invention, the portion of the language learning hardware and software system proximal to the learner machine is an interface server 403. The interface server is responsible for fast switching input and output between multiple instances of learner machines 401 and ad buyer machines 402 external to language learning system servers to send and return packet communications in the language module 404 and ad hardware cluster 405. A server or other computing component includes one or more network interfaces, computer readable medium hard drive, random access memory, and processor which communicate with each other via control bus, address bus and standard bus. The network interface provides connectivity to multiple simultaneous learner client machines and ad buyer client machines.

The interface server software stored in the computer readable medium drive is implemented by the processor and random access memory to perform rapid packet switching via network interface, taking in a request from a learner machine, returning text data and often audio, video or image files in packets from the language module 404 and ad hardware cluster 405. Because the interface server 403 relies on the language module and the ad hardware cluster to act as file servers, the interface server does not in the preferred embodiment make use of large capacity hard drives in the form of, for example, striped optical drives, arrays, or multiple blade drives for long term storage. Rather, the interface server in the preferred embodiment is specialized hardware implementing high-speed packet switching capacity in software, hardware or a combination of both. For instance, the interface server may be specialized to search for shortest network routes and/or redundant multiplexed packet streams. The interface server in the preferred embodiment implements fast random access memory with memory blocks allocated to packet buffers, also communicating to the processor the state and capacity of packet buffer memory. Interface server architecture is optimized for pass-through from the language module and ad hardware cluster to the learner machine; speed of media file upload from the learner machine is not necessary to be emphasized.

The next connection described in the language learning hardware and software system is a language module 404. For language learners who are paying directly and not seeing ads, this language module directs almost all the interactions through the interface server. As will be described in further detail, the language module comprises accounts of user language learning history and familiarity, plus text stores of language practice problems and learning reinforcements in various languages. Depending on the language teaching approach in use, the language module comprises language terms, elements or rule-items used by the teaching approach. The language module also comprises specialized storage and network server hardware for language learning media files, with audio files and audio compression systems in particular being emphasized. Along with serving audio files for language translation to the learner machine, the language module also comprises hardware and software for receiving and storing voice recordings from the learner machine, via the interface server, and processing these received voice recordings for language correctness, as explained in application Ser. No. 15/372,364 and herein.

The ad buyer machine 402 is, like the learner machine, a general purpose computing device with the capability of network access and of running language learning software as described elsewhere. The ad buyer machine, further, in the preferred embodiment of the invention, runs a version of the language learning software having ad sponsoring access. The ad buyer machine therefore communicates via the interface server 403 with the language module 404, but also uploads ad data and ad media files, via the interface server, to the ad hardware cluster 405.

The ad hardware cluster 405 is responsible for serving sponsored language practice problems as described below. Therefore, the ad hardware cluster comprises hardware and software with capacities for storing and serving sponsor-modified versions of language practice problems and accompanying sponsor audio, video and image files in-line with said language practice problems. The ad hardware cluster also comprises capacity for receiving, processing and storing sponsor modifications to language practice problems and said accompanying sponsor in-line audio, video and image files. These sponsor inputs are received from the ad buyer machine 402 via the interface server.

The ad hardware cluster also comprises an ad-to-language network link 408 with the language module 404. This specific link performs three functions. First, the ad-to-language network link allows the ad hardware cluster to query the language module for sponsorable language practice problems which it may present to an ad buyer machine 402 for sponsoring. Second, the ad-to-language network link allows the ad hardware cluster to query the language module for language learner accounts which the ad hardware cluster can use to create user profiles for ad support. Third, the ad-to-language network link 408 allows the language module to query the ad hardware cluster for sponsored versions of language practice problems which have been selected for presentation to a learner machine 401. In the preferred embodiment of the invention, because the communication along this ad-to-language network link is one-to-one rather than multiplexed, the link is direct, bypassing the interface server 403.

Finally, as shown in the network hardware diagram, the ad hardware cluster connects to a social media interface server 406. The social media interface server matches user profiles from the ad hardware cluster with public social media and ad preference data from various appropriate internet services like Overture, Google Adwords, Facebook and similar.

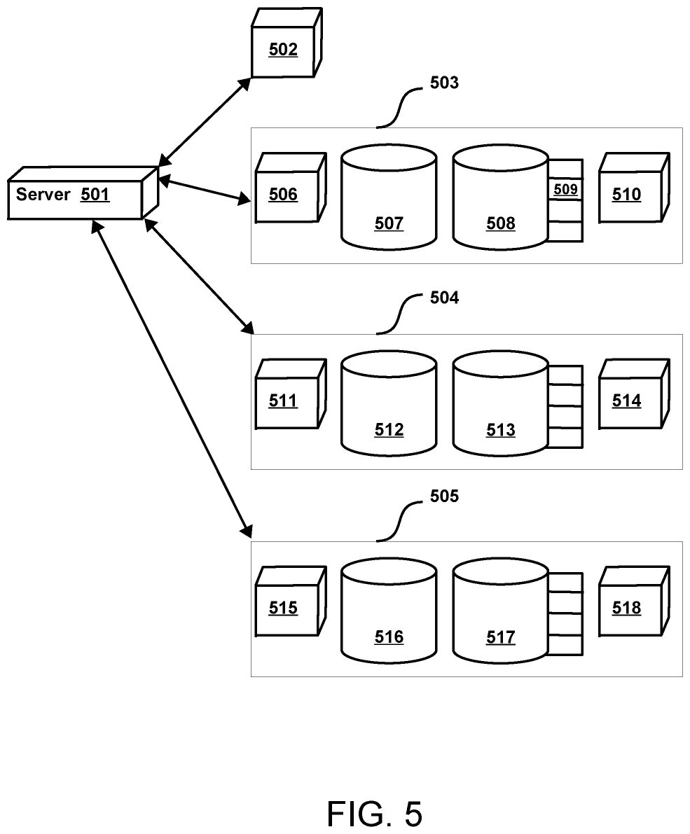

FIG. 5 depicts a more detailed diagram of the language module 404. A language module server 501 maintains network connections with a hardware device for a user language learning profile database 502. Network connections are also maintained with dedicated language learning clusters. There is one language learning cluster connected with the language module server 501 for each language taught by the ad-supported language learning system of the invention. Depicted as examples here are dedicated language learning clusters for English-Spanish 503, English-Arabic 504 and English-Polish 505.

The language module server 501 maintains a network link with a user profile server 502 storing and serving user login data, user payment data and user language learning data as described in parent application Ser. No. 15/372,364 and herein. The language module server 501 comprises a tangible, persistent state computer readable medium storing software instructions directed to functions for responding to requests from a learner machine 401 (or ad buyer machine 402), thereby serving language teaching practice problems and content with ad support as described herein.

The user profile server sends and receives only small batches of text data for multiple simultaneous users and has at least one aspect optimized in hardware or software. The database model used in the user profile server therefor is a relational-type database implementing string, date and number data types of small sizes, foregoing object, Binary Large Object (BLOB), vector, raster and other types or sizes of data. Because large data types are not handled by the user profile server in the preferred embodiment, high speed data bus architecture and large static storage components are not emphasized. Rather, fast RAM, memory management software and other means known in the art are preferred to facilitate fast updates of relational database entries.

The example English-Spanish language learning hardware cluster 503 implements four types of servers, each which can have specialized hardware and software in combination. The language text data server 506 stores practice problems, text translations and language elements or rule-items according to the language teaching approach in use. The language text data server is therefore implemented having at least one aspect optimized for efficient network and hardware performance in regard to text search results. The aspects described following as typically being aspects of the language text data server are therefore meant as aspects optimized for efficient network and hardware performance in regard to text search results. The database model used in the language text data server therefore typically has an aspect of implementing string, date and number data types of small sizes, and foregoing object, Binary Large Object (BLOB), vector, raster and comparable types or sizes of data. Because large data types are not handled by the language text data server in the preferred embodiment, the language text data server therefore typically has an aspect of de-emphasizing high speed data bus architecture and large static storage components. Rather, the language text data server typically has an aspect of fast RAM, memory management software and other means known in the art to facilitate fast updates of relational database entries, multiple high-speed database reads and memory management.

Differentiating it from the user profile server, the language text data server 506 also implements software for using the language text data in the relational database to run language learning software in response to learner machine 401 requests. The language text data server can therefore implement language learning techniques such as basic spaced repetition or, better, targeted reinforcement of language rule-items within the context of familiar speech as described in related patent Ser. No. 10/854,106. For offline modes, the learner machine 401 may store, as a mirror of the language text data server 506, a subset of the language learning software and a subset of the language text server database.

Three different indexing schemes are used, in order to improve storage efficiency and access speed for the different types of data. Differentiating it from the user profile server, the language text data servers 506 511 515 typically have an aspect of using a data structure allowing for ongoing sorting using greater than (>), less than (<) and related comparison operators beyond a simple is-equal search. This improves retrieval speed during various language teaching methods such as spaced repetition, as well as for advanced language teaching methods grouping related language rule-items that a learner is familiar with into an authentic sentence context, as explained in related patent Ser. No. 10/854,106. The data structure used for holding language data in the preferred embodiment for the language text data servers, therefore, is a b-tree data structure where non-leaf nodes have two or more (n+2) children per node. In contrast, for the user profile server 502, where usage of comparison operators outside of equal (=) do not affect access speed, a simple index is used for more efficient disk usage by preventing unnecessary block duplication. For the Binary Large Object servers described below, such as an audio lesson streaming server 508 or ad video storage device 1501, a sorting index can be dispensed with entirely since the BLOB entries are directly referenced by, respectively, a language text data server 506 entry and an ad database hardware device 1303 entry.

The three other types of server hardware/software combinations used in the example English-Spanish language learning cluster 503 facilitate the listening and speaking, rather than text response, portions of language learning. An audio input recording server 507, an audio lesson streaming server 508 and an audio analysis server 510 are shown.

An audio input recording server 507 implements a database for receiving new audio voice recordings from the learner machine 401. This database for receiving audio recordings is therefore a database instance appropriate for receiving, temporarily storing, analyzing and then deleting audio data files of a known and limited size as a Binary Large Object (BLOB) data type. The audio BLOB data is associated in the database with a language practice problem prompt and a learner machine user profile. The database model used in the audio input recording server therefor is an object-oriented database implementing BLOB (or equivalent) data types of known size. Because large data types are handled by the audio input recording server without requiring high-speed delivery in the preferred embodiment, high speed data bus architecture is not emphasized. However, a large component of fast RAM is emphasized in this server, as well as memory management software and other means known in the art are preferred to facilitate fast writes and deletions of audio files.

In the preferred embodiment, the audio lesson streaming server 508 is in some sense the obverse of the above-described audio input recording server. The audio lesson streaming server stores audio files of spoken language which are streamed or transmitted to a connected learner machine 401 as prompts that a language learner will be asked to respond to with a correct answer, such as a typed translation, spoken translation or multiple-choice response.

An audio lesson streaming server 508 implements a database for accessing persistent storage of audio voice recordings as language lesson prompts. This database for accessing audio recordings is therefore a database instance appropriate for persistently storing, accessing and then streaming or serving audio data files of a known and limited size. The audio data file is not necessarily stored in the database as a BLOB data entry, but is associated in the database with a language practice problem prompt and sent to a learner machine. Because persistent large data types are handled by the audio lesson streaming server 508 with high-speed delivery in the preferred embodiment, high speed data bus architecture is emphasized. For efficiency, static storage such as striped disk or optical drives, solid-state RAID arrays, or similar large, fast-read storage components are emphasized. Because the audio files are of a known maximum size, the audio lesson streaming server 508 is depicted with pre-allocated memory blocks 509 of size matched to the known maximum audio file size in order to improve speed and efficiency of media server memory usage.

An audio analysis server 510 implements speech recognition software for analysing speech recordings in the audio input recording server 507. This server therefore uses speech recognition software using Hidden Markov Method, neural net, or other known techniques in the art to process speech audio files of learners into text. This server uses a database or data file holding vector, lattice or other appropriate data types for recognizing speech and matching them to language data of the same types created by processing the audio speech recordings held in the audio input recording server 507. These audio data types can then be mapped to text and compared to correct practice problem answers as text. Because large data types are handled by the audio input recording server without requiring high-speed delivery in the preferred embodiment, high speed data bus architecture is not emphasized. However, a large component of fast RAM is emphasized in this server, as well as memory management software and other means known in the art are preferred to facilitate fast writes and deletions of temporary audio data type entries and corresponding text entries.

Just as in the example English-Spanish language learning hardware cluster 503, the example English-Arabic language learning hardware cluster 504 is illustrated with the preferred embodiment of a language text data server 511, audio input recording server 512, an audio lesson streaming server 513 and an audio analysis server 514. The example English-Polish language learning hardware cluster 505 is illustrated with the preferred embodiment of a language text data server 515, audio input recording server 516, an audio lesson streaming server 517 and an audio analysis server 518.

Note that specialized server hardware architectures and components described here are best methods of implementing the invention with efficiency. In other implementations, described servers and databases can be consolidated or separated if appropriate. For instance, the language text data servers could be separated into individual servers for practice problems, for translations and for language rule-items. Or, depending on performance needs, multiple languages could be served from the same language learning cluster.

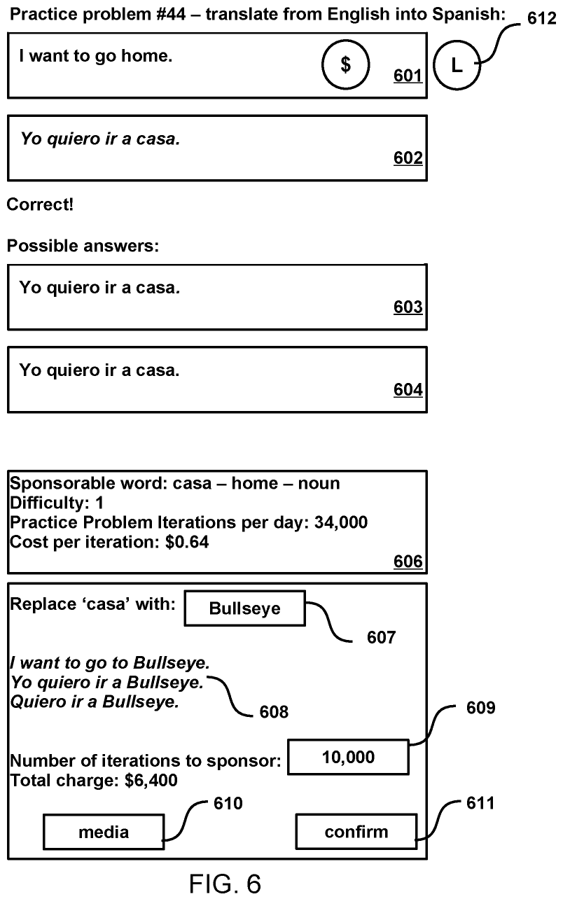

FIG. 6 illustrates a sponsorable sentence translation practice problem as seen via the sponsor's interface. The user is logged in as a language learner on an account that also has sponsor functions. A sponsor account will have been set up with information allowing the user to purchase sponsored practice problems in the language learning system and be billed by, for instance, a credit card or a deposit of funds.

The user has been presented a sentence 601 to translate, like a normal student using the system and working through a series of practice problems. The user has replied with an accurate translation 602 in the space provided and been given feedback that his response is correct. Below this, the possible accurate translations are displayed at 603 and 604.

Additionally, because the user is on a sponsor account, the language learning interface also includes sponsor functions where appropriate. The display includes an icon 605 indicating the sentence translation practice problem is sponsorable.

By clicking the selectable sponsor icon 605, the user is shown information about the sponsorable practice problem, relevant to advertising, in section 606. In this example, the sponsor sees that the sponsorable sentence translation practice problem has a low difficulty, and has a noun, “casa”, that can be replaced with a sponsor's brand or product or other term. The sponsor also sees that the practice problem is seen 34,000 times per day by various students using the sponsored version of the system, and that it would cost $0.64 per iteration to show a sponsored edit of this sentence as part of a new sponsored practice problem.

Next, interface portion 607 gives a space for the sponsor to enter a mark, brand or other word in place of the sponsorable word “casa”. In the example, the sponsor enters the retail brand “Bullseye”. In response, the interface shows the sponsor how the new sponsor mark “Bullseye” will appear in the new sentence and its translations 608.

In the case of some sponsorable practice problems, the sponsor will have the option to add a brand media file. This media file can be an audio, video, image, VR or other appropriate type of media file which can be played in-line, before, during or after, with the practice problem on a learner machine. In the preferred embodiment, there is a set file type and maximum size for sponsor media files, allowing for language learning system network server, hardware, database and software to be optimized for specific file types and sizes.

In the next interface section 609, the sponsor enters an order for the new sponsored practice problem with the new sponsor term to appear on 10,000 occasions to language students using the system, when appropriate users are found by the ad hardware cluster. A confirmation button 611 confirms the order as entered. In other embodiments, orders can be placed as a daily, weekly, or monthly allotment, with a maximum number of showings or a maximum spend per day. In some embodiments, the price of the practice problem varies using a bid system, with the sponsor selecting a maximum bid and seeing the normal bid range.

Some sponsorable practice problems allow for attaching a sponsor media file in lieu of, or in addition to, the sponsor text attachment described above. Media attachment button 610 shows an example interface element that starts an upload of an audio, video, image, virtual reality (VR) or other supported media file type. As is explained following, in the preferred embodiment, allowed media file formats and sizes are pre-set, in order that back end network hardware elements of the invention are configured to efficiently store and serve such uploaded media files. Depending on the type of media and the configuration of the sponsorable practice problem, the sponsor media file can display just before, during, or just after the practice problem on a learner machine.

Finally, another icon 612 allows the sponsor to switch to a keyword search interface, where the user may simply browse through sponsorable practice problems by keyword or subject, rather than by interacting with the language learning interface as a student.

In some embodiments, new sponsored practice problems may require a final check by an administrator before going live. Custom sponsored practice problems intended to comprise a sponsors specific phrase will be created and added to a database of practice problems in other embodiments.

Some sponsorable practice problems allow for attaching a sponsor media file in lieu of, or in addition to, the sponsor text attachment described above. Media attachment button 612 shows an example interface element that starts an upload of an audio, video, image, virtual reality (VR) or other supported media file type. As is explained following, in the preferred embodiment, allowed media file formats and sizes are pre-set, in order that back end network hardware elements of the invention are configured to efficiently store and serve such uploaded media files. Depending on the type of media and the configuration of the sponsorable practice problem, the sponsor media file can display just before, during, or just after the practice problem on a learner machine.

Not all practice problems are set up as being sponsorable. It is noted that this interface example is illustrative and may have other aspects. For instance, where an advertiser wishes to sponsor an audio response to a sentence, the interface may include means for uploading a voice recording for the word rule-items of the practice problem.

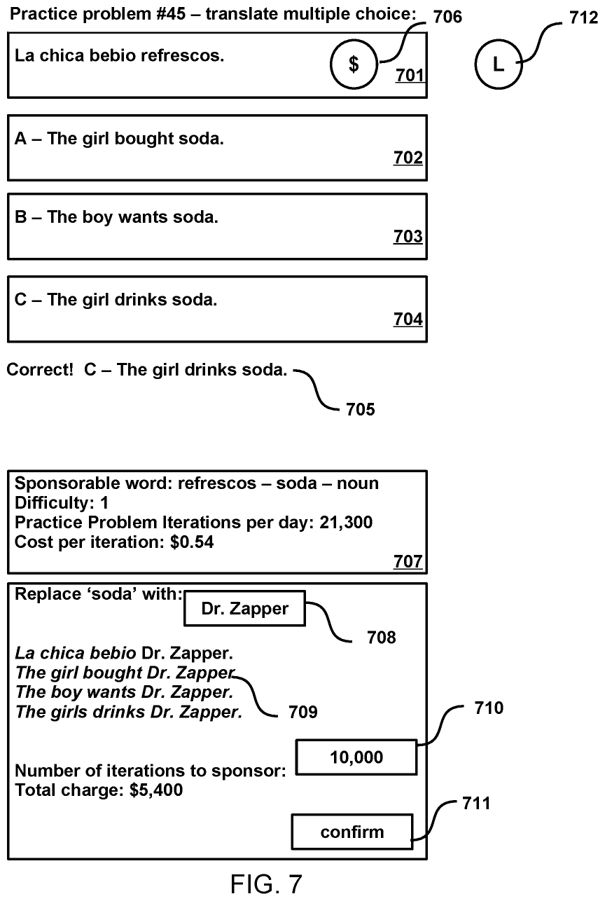

FIG. 7 illustrates a sponsorable multiple choice practice problem as seen via the sponsor's interface, as is described above according to FIG. 6.

The user has been presented a sentence 701 for which to choose a correct translation via multiple choice, like a normal student using the system and working through a series of practice problems. The user has replied has skipped over inaccurate translations at 702 and 703, selecting the accurate translation at 704. The system gives him feedback that his response is correct 705.

Additionally, because the user is on a sponsor account, the language learning interface also includes sponsor functions where appropriate. The display includes an icon 706 indicating the multiple choice practice problem is sponsorable.

By clicking the selectable sponsor icon 706, the user is shown information about the sponsorable practice problem, relevant to advertising, in section 707. In this example, the sponsor sees that the sponsorable multiple choice practice problem has a low difficulty, and has a noun, “refrescos”, that can be replaced with a sponsor's brand or product or other term. The sponsor also sees that the practice problem is seen 21,300 times per day by various students using the sponsored version of the system, and that it would cost $0.54 per iteration to show a sponsored edit of this sentence as part of a new sponsored practice problem.

Next, interface portion 708 gives a space for the sponsor to enter a mark, brand or other word in place of the replaceable word “refrescos”. In the example, the sponsor enters the soda brand “Dr. Zapper”. In response, the interface shows the sponsor how the new sponsor mark “Dr. Zapper” will appear in the new sponsored sentence and its multiple choice translation options 709.

In the next interface section 710, the sponsor enters an order for the new sponsored practice problem with the new sponsor term to appear on 10,000 occasions to language students using the system, when appropriate occasions arise, for a total cost to the sponsor of $5,400. A confirmation button 711 confirms the order as entered.

Finally, another icon 712 allows the user to switch to a keyword search interface, where the user may simply browse through sponsorable practice problems by keyword, rather than by interacting with the language learning interface as a student.

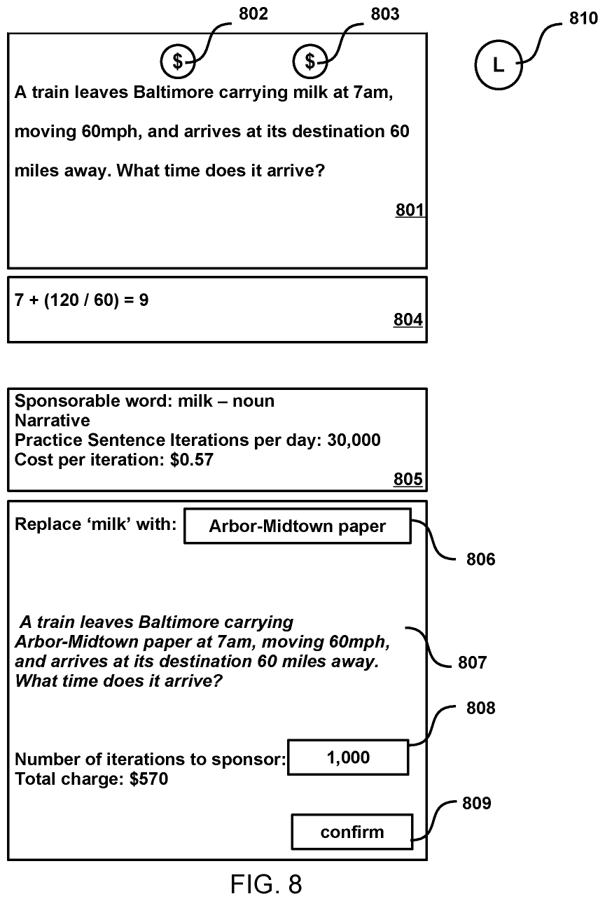

FIG. 8 illustrates a sponsorable arithmetic word problem as seen via the sponsor's interface. The user is logged in as a mathematics learner on a sponsor account and has been presented a word problem 801 to work. Sponsorable words in the word problem are indicated by a clickable icon 802 for the noun “Baltimore” and a clickable icon 803 for the noun “milk”. The user has worked the problem in the answer section 804, arriving at the correct answer.

Having clicked on the sponsor icon 803 for “milk”, the user is shown information about the sponsorable word relevant to advertising in section 805. In this example, the sponsor sees that the sponsorable word-item “milk” is a noun with a narrative function in the word problem. The sponsor also sees that the word-item is seen 30,000 times per day as part of this particular word problem, and that it would cost $0.57 per iteration to show a sponsored edit of this word problem as part of a new sponsored word problem.

Next, interface portion 806 gives a space for the sponsor to enter a mark, brand or other word or phrase in place of the sponsorable word “milk”. In the example, the sponsor enters the branded commodity “Arbor-Midtown paper products”. In response, the interface shows the sponsor how the new sponsored rule-item “Arbor-Midtown paper products” will appear in the new word problem 807. Because the sponsorable nouns in a mathematical word problem serve a narrative function, a broad range of sponsor phrases can be substituted without interfering with teaching functions.

In the next interface section 808, the sponsor enters an order for the new word problem with the new sponsored rule-item to appear on 1,000 occasions to mathematics learners using the system, when appropriate occasions arise, at a total cost of $570. A confirmation button 809 confirms the order as entered.

Finally, another icon 810 allows the user to switch to a keyword search interface, where the user may simply browse through sponsorable word problems by keyword or subject, rather than by interacting with the mathematics learning interface.

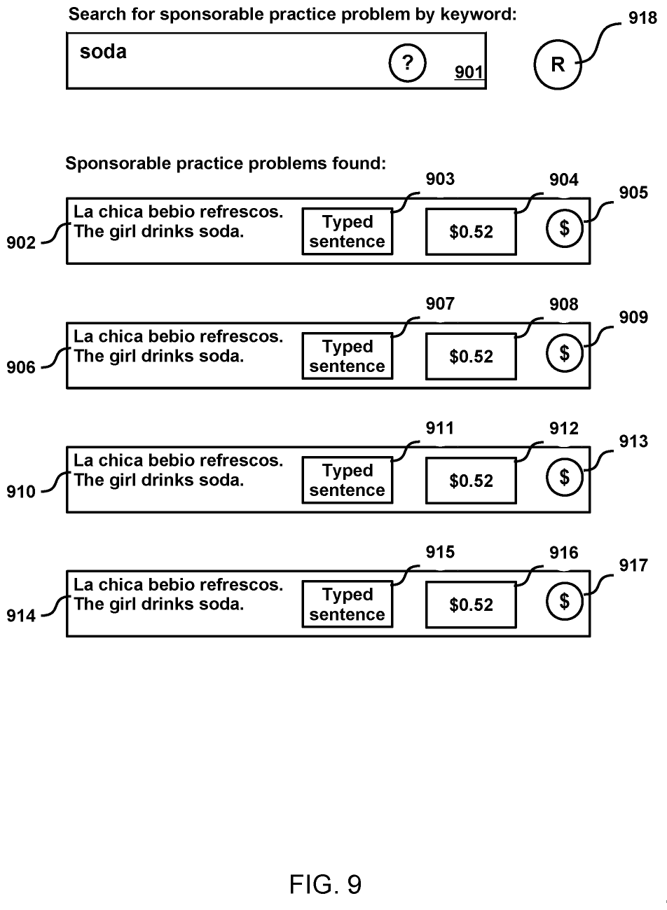

FIG. 9 illustrates using a search to browse sponsorable practice problems in the sponsor's interface. When logged into a sponsor account, a user who has selected the search icon, as shown in item 812 of FIG. 8, is taken out of the standard student interface of shown a text input box 901 for searching by keyword. Enhanced embodiments of the browsing interface will also allow the sponsor to locate practice problems according to subject matter, using content lists as well as by the illustrated keyword search.

In the example, the sponsor has searched for the word ‘beverage’, turning up two practice problems with the keyword ‘beverage’ and two other practice problems sponsorable in the beverage category. First in the results list is the example sentence 902 “La chica bebio una bebida” listed with the translation “The girl drinks a beverage”. Also shown in the illustrated embodiment are an indicator 903 that the practice problem will appear in the form of a typed translation.

Indicator 904 tells the sponsor that sponsoring this practice problem will cost $0.52 per iteration. This cost per iteration may be set to fluctuate according to an algorithm such as one based on demand. This cost may also be based on various characteristics of the practice problem, such as its difficulty or how many times per day it is shown. The cost may be set by a subjective judgment of a system administrator. A combination of these factors may be used. By clicking sponsor icon 905, the sponsor selects the practice problem and is taken to a sponsor screen such as that of FIG. 7. Costs, frequency of appearance, and other information affecting a prospective sponsor's evaluation of the practice sentence may also be referred to as items of sponsoring data for the purposes of this application.

Second in the results list is the example sentence 906 “La chica bebio refrescos”, also listed with the translation “The girl drinks soda”. Indicator 907 here indicates that this practice problem will appear in the form of a multiple choice selection.

Indicator 708 tells the sponsor that sponsoring this example practice problem will cost $0.54 per iteration, with the slightly higher cost than sentence 902 perhaps caused by increased sponsor demand for multiple choice practice problems. By clicking sponsor icon 909, the sponsor selects the practice problem and is taken to a sponsor screen such as that of FIG. 7.

Third in the results list is the example sentence 910 “You can't have soda for breakfast”, also listed with the translation “Nose puede tener de soda para el desayuno”. Indicator 911 here indicates that this practice problem will appear in the form of a typed translation.

Indicator 912 tells the sponsor that sponsoring this practice problem will cost $0.07 per iteration. By clicking sponsor icon 913, the sponsor selects the practice problem and is taken to a sponsor screen such as that of FIG. 7.

Fourth in the results list is the example sentence 914 “My favorite drink is tea”, also listed with the translation “Mi bebida favorita es el to”. Indicator 915 here indicates that this practice problem will appear in the form of an audio recording.

Indicator 916 tells the sponsor that sponsoring this practice problem will cost $0.90 per iteration, perhaps owing to the audio message. By clicking sponsor icon 917, the sponsor selects the practice problem and is taken to a sponsor input screen such as that of FIG. 7, with added interface elements for uploading an audio recording or notifying the system administrator or marketing administrator to create a new sponsored audio practice problem including the sponsor's brand or mark. Selectable icon 918 takes the user out of the keyword search interface back to the student interface.

In some systems, the format of the practice problem will be not be relevant in the sponsor's practice problem search interface. For instance, in some language learning systems, the format of a practice problem will vary dynamically with the sponsored practice problem appearing in any of the valid formats. In other systems, only one format will be available. In embodiments of the invention used in connection with such systems, the practice problem format indicators 903, 907, 911 and 915 will not appear.

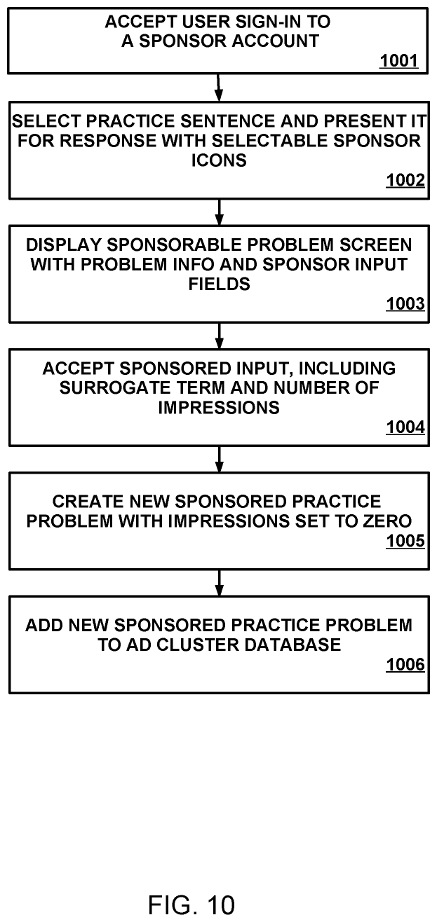

FIG. 10 is a flowchart illustrating an in-situ method whereby an advertiser sponsors a practice problem in the language learning system. In step 1001, the system accepts a sign-in of a user of the language learning system to a sponsor account, by which is meant a user account that allows for language learning functions and functions related to purchasing and tracking of sponsored practice problems.

In step 1002, the language learning system selects a practice problem for the signed in user, and presents it to him for response via typed translation, audio response or other appropriate response, just as it would for a normal user on a learner machine. That is, a non-sponsored practice problem presented for student translation on a learner machine will be presented using a network of at least some of the specialized hardware systems described according to FIGS. 4, 5, 13, 14 and 15. The non-sponsored practice problems presented on and ad buyer machine 402 are presented using the same network systems, with additional sponsoring options as described below.

In addition to the normal student response options, any sponsorable practice problem will, when presented on an ad buyer machine, have selectable icons for initiating sponsoring of that practice problem. In step 1003, the language learning system responds to selection of a sponsor icon by displaying practice problem information and sponsor input fields.

In step 1004, the system accepts practice problem sponsoring details transmitted by the user via the sponsor input fields. These sponsoring details include the surrogate term, meaning the sponsor's brand or product name or other term the sponsor wishes to place in the sentence. Other sponsoring details include the number of times the sponsored practice problem, now edited to include the sponsor's term, should appear to other students in the sponsored version of the language learning system.

In step 1005, a new sponsored practice problem is created, based on the original practice problem presented in step 802 but now including the new sponsor's surrogate term added in step 1004. Because the practice problem is new, a field tracking the number of times it has been seen by a student is initialized to zero. Finally, in step 1006, the new practice problem created in step 1005 is added to the practice problem database for the system. Because the new practice problem with sponsor information is added, and the original practice problem is not removed, the number of practice problem available to the system is increased by one.

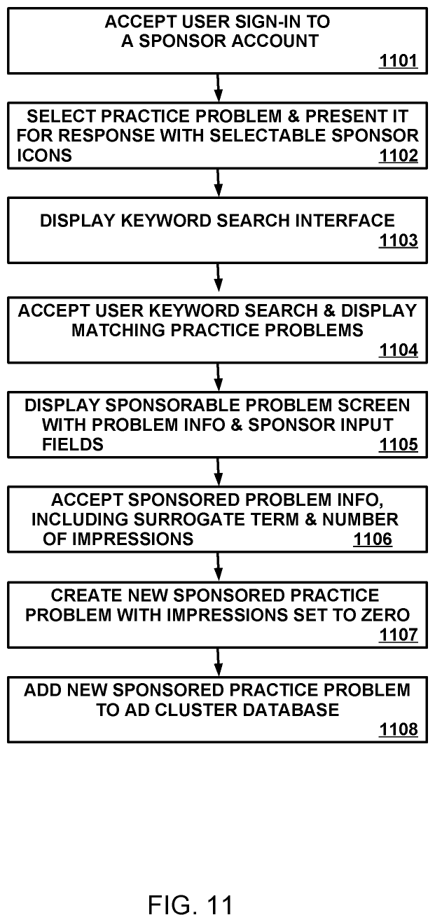

FIG. 11 is a flowchart illustrating a variation of FIG. 10, whereby an advertiser sponsors a practice problem in the language learning system using a direct keyword search. In step 1101, the system accepts a sign-in of a user of the language learning system to a sponsor account. In step 1102, the system presents a practice problem or other language learning screen, with an selectable keyword search icon. In step 1103, the system responds to the user's selection of the keyword search icon by opening a keyword search interface.

In step 1104, the system responds to the user's keyword search by displaying matching practice problems. that the signed-in user has selected via keyword search. In step 1105 the language learning system responds to selection of a sponsorable practice problem by displaying the problem's information and sponsor input fields.

In step 1106, the system accepts sponsoring details transmitted by the user via the sponsor input fields. In step 1107, a new sponsored sentence or other practice problem is created, based on the original practice problem presented in step 1105 but now including the new surrogate term added in step 1106. Finally, in step 908, the new practice problem created in step 1107 is added to the database for the system.

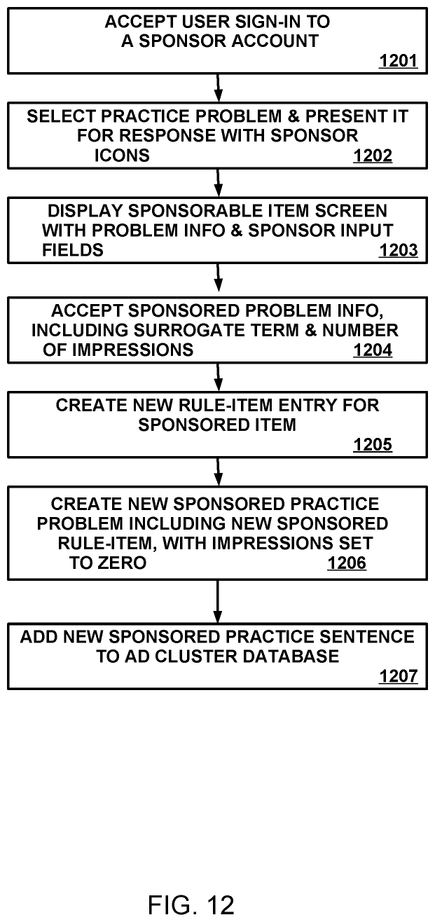

FIG. 12 is a flowchart illustrating a variation of FIG. 10 that can be used in language learning systems that have translatable sentences or other practice problems composed of word rule-items, sentence governing rule-items, or other language concepts used to compose a sentence. A language practice problem being described as ‘translatable’ in the context of this application means it can be answered or responded to with a full translation, partial translation, or some other form of appropriate solution such as choosing a correct multiple choice option. Similarly, a translation can be taken to refer to a full translation, partial translation, or some other form of appropriate response such as choosing a correct multiple choice option.

In step 1201, the system accepts a sign-in of user of the language learning system to a sponsor account. In step 1202, the language learning system selects a practice problem for the signed in user according to the practice problem selections methods described above, and presents it to him for response via typed translation, audio response or other appropriate response. In addition to the normal student response options, any sponsorable word rule-item in the presented practice problem will have selectable icons for initiating sponsoring of that word rule-item. In step 1203, the language learning system responds to selection of a sponsorable item in the practice problem by displaying the rule-item's information and sponsor input fields.

In step 1204, the system accepts rule-item sponsoring details transmitted by the user via the sponsor input fields. These sponsoring details include the surrogate term, meaning the sponsor's brand or product name or other term the sponsor wishes to replace the word with in the practice problem. Other sponsoring details include the number of times the sponsored practice problem, now edited to include the sponsor's term, should appear to the students of the language learning system.

At step 1205, a new rule-item is created, based on the original rule-item but now including the new information created in step 1204. In step 1206, a new sponsored practice problem is created, based on original practice problem presented in step 1202 but now including the new sponsored rule-item created in step 1205. Because the practice problem is new, a field tracking the number of times it has been seen by a student is initialized to zero. Finally, in step 1207, the new practice problem created in step 1206 is added to the practice problem database for the system. Because the new practice problem with sponsor information is added, and the original practice problem is not removed, the number of practice problems available to the system is increased by one.

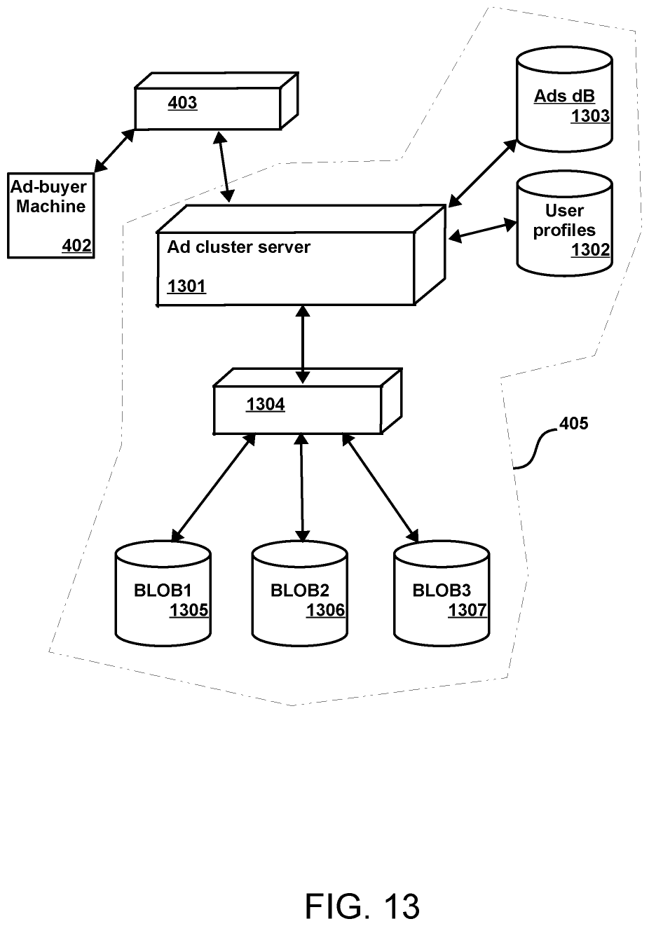

FIG. 13 depicts a more detailed diagram of the ad hardware cluster 405. An ad hardware cluster server 1301 comprises a tangible, persistent state computer readable medium storing software instructions for responding to requests from language module 404, thereby serving ad support concurrent with language teaching practice problems and content. The ad hardware cluster server 1301 maintains network connections with a user ad profile database hardware device 1302 and an ad database hardware device 1303. Network connections are also maintained with dedicated BLOB server groupings 1304, 1305 and 1306. An ad media load balancing server 1307 distributes traffic between the separate BLOB server groupings. A preferred embodiment uses a modulator/demodulator communication method going from the ad media load balancing server to the learner machine. Because the ad media load balancing server 1307 serves time-sequenced audio and video files, a preferred embodiment implements a code rate of 1/5 or better, producing five encoded bits for each data bit per packet data packet when sending audio or video to be received at the appropriate learner machine 401. This server method provides a relatively high amount of redundancy, preventing audio and video dropouts.

The social media interface server 406 pulls in external social media ad profiling data. The social media interface server matches user profiles stored on the user ad profile database hardware device 1302 with public social media and ad preference data from various appropriate internet services like Axciom, Overture, Google Adwords, Facebook and similar marketing data services. This social media ad preference data can then be added to the user ad profile database hardware device 1302 via the ad hardware cluster server 1301. Therefore, when a user at a learner machine 401 becomes eligible for a sponsored practice problem, the determination of whether to show a sponsored practice problem at the current iteration or a different sponsored practice problem at a different appropriate point in the user's learning process can be informed by information generated within the language learning servers combined with information generated by external processes.

When a sponsor at an ad buyer machine 402 sponsors a practice problem, this copies a practice problem already located in the appropriate dedicated language learning cluster hardware for the given language taught. The practice problem is copied via a direct network link 408 between the language module 404 and the ad hardware cluster 405 that bypasses the public-facing interface server 403. The new sponsored practice problem is stored in the ads database server 1303 with a reference or pointer to the sponsor advertising message which can later be shown in situ with a practice problem presented to a user at a learner machine 401 in the normal course of language instruction and reinforcement. Where the sponsor advertising message referenced is simply text, sponsor advertising message itself can also be stored in the ads database server.

The ads database server also stores ad prices, ad impressions, and other ad metrics. The database model used in the ads database server therefor is a relational-type database implementing string, date and number data types of small sizes, foregoing object, Binary Large Object (BLOB), vector, raster and other types or sizes of data. Because large data types for ads are only referenced by the ads database server 1302 in the preferred embodiment, high speed data bus architecture and large static storage components are not emphasized. Rather, fast RAM, memory management software and other means known in the art are preferred to facilitate fast updates of relational database entries.

Where the sponsor advertising message is in the form of a referenced image file, audio file or video file, said referenced file is stored in a BLOB server which is part of an ad BLOB cluster. Ad BLOB clusters 1304, 1305 and 1306 are mirrors of each other, redundantly storing sponsored practice problem image files, audio files and video files for load-balanced network service of said media files to be inserted in-line with sponsored practice problems presented on learner machines 401. The ad BLOB clusters are, ideally, geographically distributed to reduce ping times for served media. A load balancing server 1307 optimized for packet switching and media file streaming intermediates between the ad BLOB clusters and the ad hardware cluster server 1301.

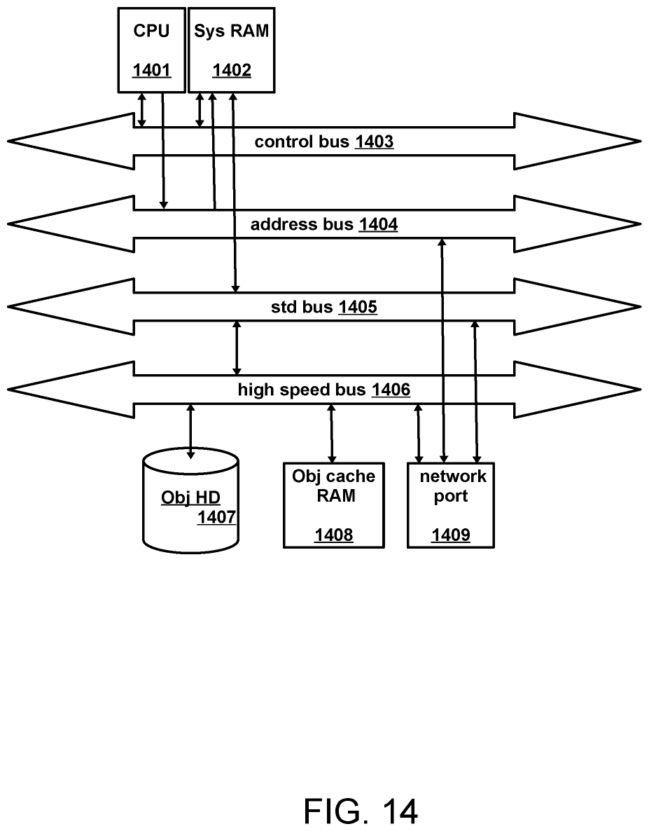

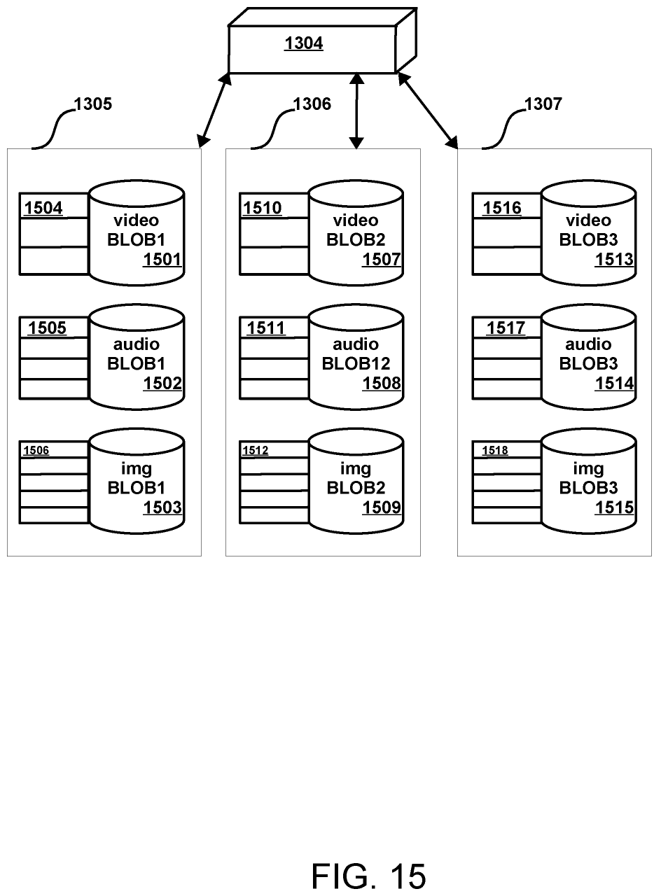

FIG. 14 depicts a system architecture with a high-speed bus and caching. In the preferred embodiment, this type of high-speed bus system architecture can be implemented in a dedicated audio streaming server such as the example audio lesson streaming server 508 described above in regard to FIG. 5 and implemented in the ad media streaming servers described below in regard to FIG. 15.

In the depicted embodiment, a central processor 1401 runs server software instructions for storing and serving large media files, with the server software instructions being stored live in adjacent system memory 1402. The system architecture may include a variety of hardware elements and components and may be rearranged where functional. A central processor with on-chip memory for system software instructions may be used, or the system cache and processor may be installed together as a “processor core”. The high-speed bus may be coupled to the processor or processor core by a “host bridge”. The standard and high-speed bus may, in some versions, coupled by an I/O bus bridge. The central processor directs connected hardware portions system memory 1402, Binary Large Object (BLOB) hard drive 1407, Binary Large Object (BLOB) cache RAM 1408 and network port 1409 via control bus 1403 and address bus 1404. BLOB cache RAM can hold media files frequently accessed, and also store media files that are next in line to be accessed as part of the language learning process.

A standard data bus 1405 handles media inputs, where speed is not critical. Where speed of recall from storage and output is critical, BLOB hard drive, BLOB cache RAM and network port are connected directly to the high-speed data bus 1406.

The BLOB hard drive 1407 comprises a tangible computer readable medium. Each ad BLOB cluster hard drive as implemented here stores a database for accessing persistent storage of image, audio or video media files referenced by sponsored practice problems. These databases for accessing sponsor media files are therefore databases instance appropriate for persistently storing, accessing and then streaming or serving image, audio or video data files of a known and limited size. Because persistent large data types are handled by the servers of an ad BLOB cluster 1304 with high-speed delivery in the preferred embodiment, high speed data bus architecture is emphasized. For efficiency, static storage such as striped disk or optical drives, solid-state RAID arrays, or similar large, fast-read storage components are emphasized. This high speed data bus architecture is similarly preferred for an audio lesson streaming server serving only audio files.

FIG. 15 depicts a more detailed view of ad BLOB server groupings 1304, 1305 and 1306 of an ad hardware cluster 405. Because ad-associated media is pre-determined to consist of audio, video and image files, the language learning system can specify the maximum file sizes for each type to be used in sponsored practice problems. This allows for three different types of media storage devices to operate with speed and efficiency in each ad hardware cluster.

As shown, BLOB server cluster 1304 comprises a video storage device 1501, an audio storage device 1502 and an image storage device 1503. Each video, audio and image storage device implements Binary Large Object database software and high speed data bus architecture as described above. Further, because the image ad files, audio ad files and video ad files can be known to be within prescribed file sizes, memory blocks in each of the devices can be pre-allocated to match the maximum file size served by each of video storage device 1501, audio storage device 1502 and image storage device 1503, respectively.

To depict this memory allocation scheme, indicated as part of the video storage device 1501 is a persistent hardware memory 1504 with stylized large memory blocks allocated to match the largest file size accepted for ad-associated video files. Also indicated as part of the audio storage device 1502 is a persistent hardware memory 1505 with stylized smaller memory blocks allocated to match the largest file size accepted for ad-associated audio files. And, depicted as part of the image storage device 1503 is a persistent hardware memory 1506 with yet again smaller stylized memory blocks allocated to match the largest file size accepted for ad-associated image files.

Similarly, ad BLOB server cluster 1305 depicts a video storage device 1507 having persistent hardware memory 1507 showing stylized large memory blocks allocated to match the largest file size accepted for ad-associated video files, an audio storage device 1508 having persistent hardware memory 1511 showing stylized memory blocks allocated to match the largest file size accepted for smaller ad-associated audio files, and an image storage device 1509 having persistent hardware memory 1512 showing stylized still-smaller memory blocks allocated to match the largest file size accepted for ad-associated image files.

And, ad BLOB server cluster 1306 depicts a video storage device 1513 having persistent hardware memory 1516 showing stylized large memory blocks allocated to match the largest file size accepted for ad-associated video files, an audio storage device 1514 having persistent hardware memory 1517 showing stylized memory blocks allocated to match the largest file size accepted for smaller ad-associated audio files, and an image storage device 1515 having persistent hardware memory 1518 showing stylized still smaller memory blocks allocated to match the largest file size accepted for ad-associated image files.

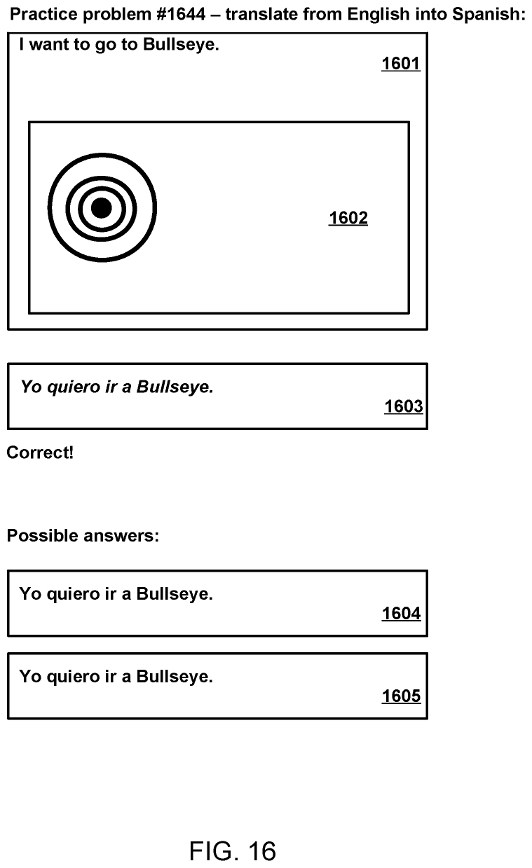

FIG. 16 illustrates a sponsored sentence translation practice problem as presented to a student using a sponsor-supported version of a language learning system, according to the invention. The student has been presented a sentence 1601 to translate, as part of working through a series of practice problems. The sponsor term ‘Bullseye’ is in the text of the practice problem, replacing an appropriate word, such as a location, building or geographical proper noun, from a related non-sponsored practice problem. Interface visual area 1602 shows a sponsor image or video or other media file, such as can be included according to the description of FIG. 6. Audio VR and other media files can also be included in this area, or in a related separate window or time frame as appropriate to the type of media.

The user has replied with an accurate translation 1603 in the space provided. The student's translation or response is compared with at least one translation response aspect that is stored on a language text data server. The instructions for checking the student's translation response may be stored on the learner machine or on a non-volatile memory that is part of language module server hardware (or language module equivalent in an ad cluster) of the hardware network of the invention, as can the processor for implementing those instructions. The translation response aspect refers to a portion of language that must be learned, such as a word translation or a sentence word order rule. The choice of translation response aspect included in the practice problem depends on the language teaching approach. The translation response aspect can, depending on the system hardware configuration, be compared with the students translation on a portion of the language module and then sent back to the learner machine, or else sent to the learner machine to be compared with the student's translation.

The student had been given feedback that his response is correct. Below this, the possible accurate translations are displayed at 1604 and 1605.

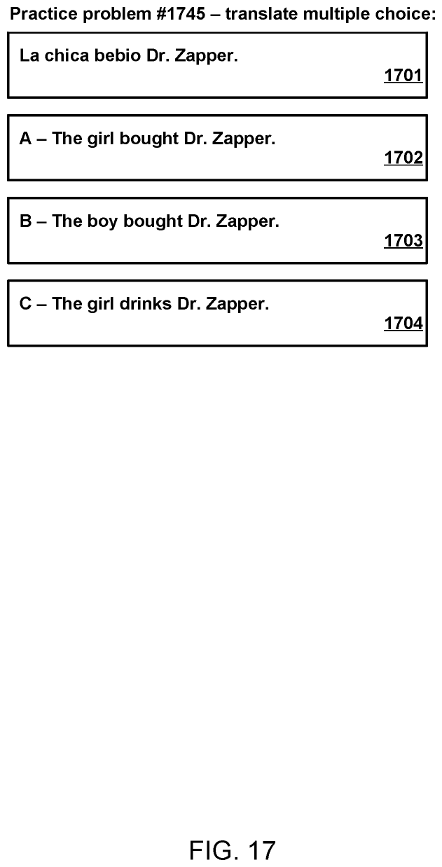

FIG. 17 illustrates a sponsored multiple choice practice problem as presented to a student using a sponsor supported version of a language learning system. At section 1701, the user is shown the translatable sentence of the sponsored practice problem, with the sponsor's surrogate branding or product term included. Where there are multiple possible sponsors for a current or upcoming practice problem, the system employs user profile data to determine the most appropriate sponsored problem to show. This user profile data, as explained above, can be intrinsic, coming from user location, language learning, ad response and other data coming from the user's engagement with the language learning system. This user profile data, as explained above, can also be extrinsic, coming from the social media interface server 406. In section 1702, the user is presented a first of multiple choices for translating the sentence. In section 1703, the user is presented a second of multiple choices for translating the sentence. In section 1704, the user is presented the third and correct one of multiple choices for translating the sentence. Each translation option includes the surrogate term.

In some instances, the sponsored practice problem includes not just sponsor in-line surrogate text, but an in-line audio, video, image, virtual reality (VR) or other appropriate type of media file. This sponsored practice problem with in-line media, in the preferred embodiment, reaches the learner machine over the sponsored language learning system hardware network. As described above, in the best mode the sponsored practice problem is stored on a text data server of an ad cluster and the in-line binary media file is stored on an ad BLOB server groupings of an ad hardware cluster. In-line sponsor media here means the sponsor media file can play in proximity, before, during, in conjunction with or after the practice problem.

The ad hardware cluster has a database server characterized as having at least one aspect optimized for efficient network and hardware performance in regard to binary large object files. As described above, these aspects can include pre-allocated memory blocks 1504 matched to expected file sizes; high speed data bus 1406 architecture; simple (or no) indexing 1501; databases configured for BLOB data types (see FIG. 15); and direct pointers to BLOB database entries from entries in B-tree indexed text search databases (see FIG. 13).

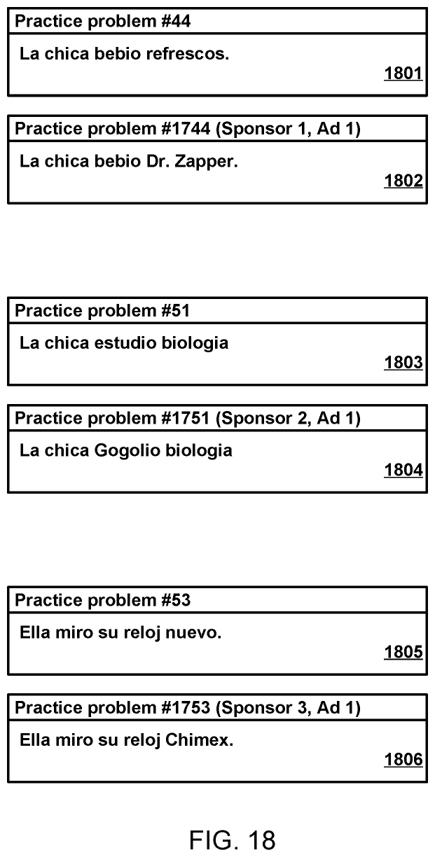

FIG. 18 is a diagram representing three example sentence translations that have been edited to include sponsor terms. The first sentence shows a noun replaced by a sponsored noun. The second sentence shows a verb replaced by a sponsored verb. The third sentence shows an adjective replaced by a sponsored adjective.

The first example illustrates how a sponsored practice problem works by replacing a regular noun with a surrogate noun referring to a trademark or product of a sponsor. The practice problem 1801 presenting the sentence “La chica bebio refrescos” and translatable as “The girl drinks soda” can be altered to illustrate a sponsored practice problem 1802 that mentions the sponsor by replacing the noun ‘soda’ (refrescos) with the surrogate term ‘Dr. Zapper’, referring to a soda produced by said sponsor. The new sponsored practice problem entry keeps track of the its relationship to the original, non-sponsored practice problem and its relationship to the sponsor's account. The sponsor can also, in some instances, include a brand media file

The sponsor can also, in some instances, include, by uploading, a brand media file in the form of an audio, video, image, VR or other media file. This media file will then later play in-line with the sponsored practice problem on learner machines.

The student learning to translate using the system of the invention will thereby encounter the sponsor's brand name while responding to this practice problem. Depending on the type of response asked of him by the presentation of the sponsored practice problem, he will speak or type the brand name in the course of speaking or typing the rest of the words. Thus, the advertising is deftly presented and actively engaged by the student without interrupting his free learning process.

Although The second example illustrates how a sponsored practice problem works by replacing a regular verb with a sponsor name capable of being used as a verb. The practice problem 1803 containing the sentence “La chica studio biologia” translatable as “The girl studied biology” can be altered to illustrate a sponsored practice problem 1804 that mentions the sponsor by taking verb ‘studied’ (estudio) and replacing it with the surrogate term ‘Gogoled’, a verb form of the sponsor's brand name or product.

The third example illustrates how a sponsored practice problem works by replacing a regular adjective with a sponsor name capable of being used as an adjective. The practice problem 1805 containing the sentence “Ella miro su reloj nuevo” translatable as “The girl checked her new wristwatch” can be altered to illustrate a sponsored practice problem 1806 that mentions the sponsor by taking adjective ‘new’ (nuevo) and replacing it with the surrogate term ‘Chimex’, the sponsor's brand of wristwatch.

In each case, the original practice problem remains when the new, sponsored practice problem is created. Each new sponsored practice problem is tracked like a non-sponsored one. However, sponsored practice problems may have relaxed rules as to how the system assesses the correctness of the student's responses. Correct spelling and pronunciation of the sponsor's surrogate term may help track the effectiveness of the advertising attempt, but may not be so important for the student's language learning.

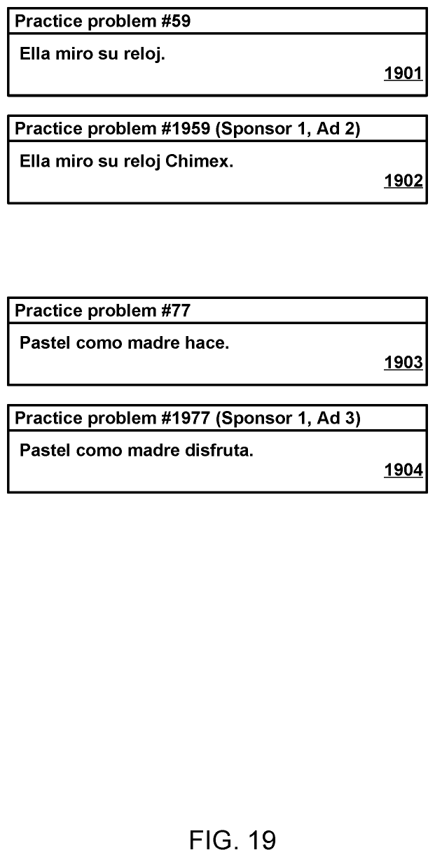

FIG. 19 is a diagram representing two examples of sentences edited to include sponsor terms in more complex manners. The first example shows inserting a sponsored adjective into a sentence. The second example shows a sentence edited to display a sponsor's slogan by replacing more than one word with surrogate terms. These examples illustrate the additional considerations involved when making more complex changes to a practice problem.

In the first example, the sentence “Ella miro su reloj” 1901 translatable as “She checked her wristwatch” is altered to illustrate a sponsored sentence 1902 that mentions the sponsor by inserting the new, additional adjective ‘Chimex’ to describe the noun ‘reloj’. However, this addition may affect, for instance, the word order in a given language.

In the second example, an edit to sentence 1903 is made by, first, replacing common noun ‘Sopa’ with a different common noun ‘Pastel’. A verb ‘pace’ is replaced by a second verb ‘disfruta’, giving the new, sponsor-edited sentence 1904 “Pastel como madre disfruta”, translatable as the sponsor's slogan “Cake like mother loves”. Because the common words here are more critical for language learning than are brand terms, proper conjugations, word choices and word orders are important when switching one common word for another.

Thus, when a sponsor desires custom or more extensively edited sentences to appear in sponsored practice problems, an additional step of verification by language learning system administrator may be required before the new sponsored practice sentence goes live.

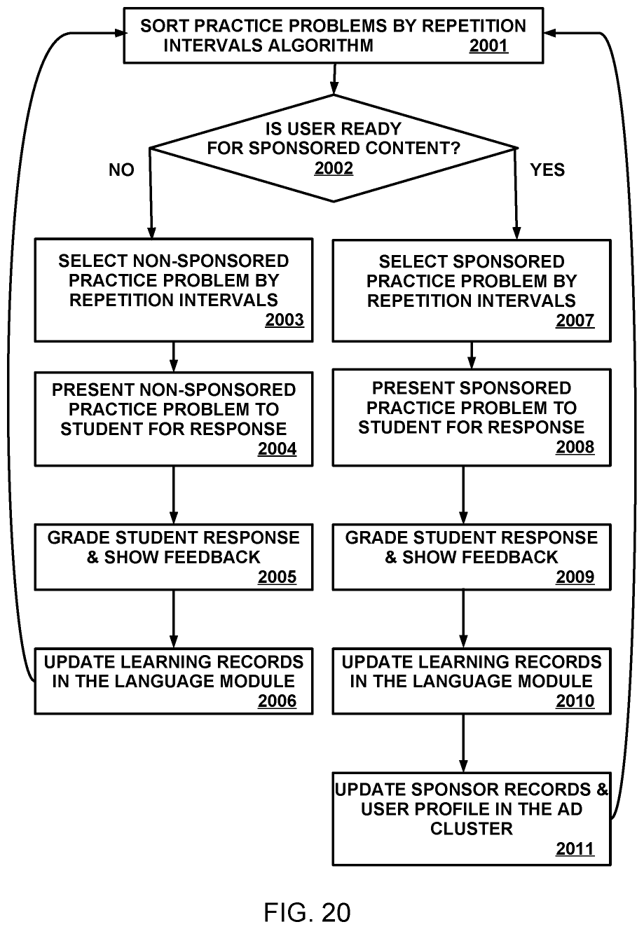

FIG. 20 is a flowchart indicating a first method of selecting, presenting and showing feedback for a sponsored practice problem according to the invention. This method provides that sponsored content is shown at specifically determined intervals, with spaced repetition based on language learning aspects being of secondary selection importance on such occasions.

In the first step 2001, the system sorts the practice problems in its database according to repetition intervals as determined by its spaced repetition algorithm. Next 2002, the system determines whether the user is ready to see sponsored content. This determination depends on whether the user is using a paid version or advertising supported access to the system, how much time has elapsed since the user last saw sponsored content and how many practice problems the user has seen since last being presented with sponsored versions.

If the outcome of step 2002 is that the user is not to see sponsored content, step 2003 proceeds to the selection of non-sponsored learning content. A non-sponsored practice problem for which the repetition interval has passed is selected, because the repetition interval having passed indicates that the student will benefit from being quizzed on that practice problem at that time.

In step 2005, the system receives the student's response to the presentation of the practice problem, evaluates it for correctness, and then presents feedback to the student, telling him whether or not he got it correct with whatever degree of specificity the system allows. In step 2006, the learning records for the practice problem are updated, indicating whether or not the student responded correctly, and thus altering the interval between now and the next repetition of the same practice problem.

for his response. The presentation interface will allow for a typed translation, multiple choice selection, audio response, or whichever sort of response is called for by the practice problem selection.

However, if the user is to be presented sponsored content, the next step 2007 is for the system to search its database for sponsored practice problems and select one for which the repetition interval has passed. This repetition interval will typically be directly related to the repetition interval for the non-sponsored practice problem from which the selected practice problem was created.

In step 2008, the practice problem is presented to the student for his response. In step 2009, the system receives the student's response to the presentation of the practice problem, evaluates it for correctness, and then presents feedback to the student. In step 2010, the learning records for the sponsored practice problem are updated, indicating whether or not the student responded correctly, and thus altering the interval between now and the next repetition of the same practice problem. Finally, in step 2011, the sponsor records for the practice problem are updated, tracking for the sponsor how many times this sponsored practice problem has been seen and how often students are responding. Sponsor records may also be referred to as items of sponsor data for the purposes of this application.

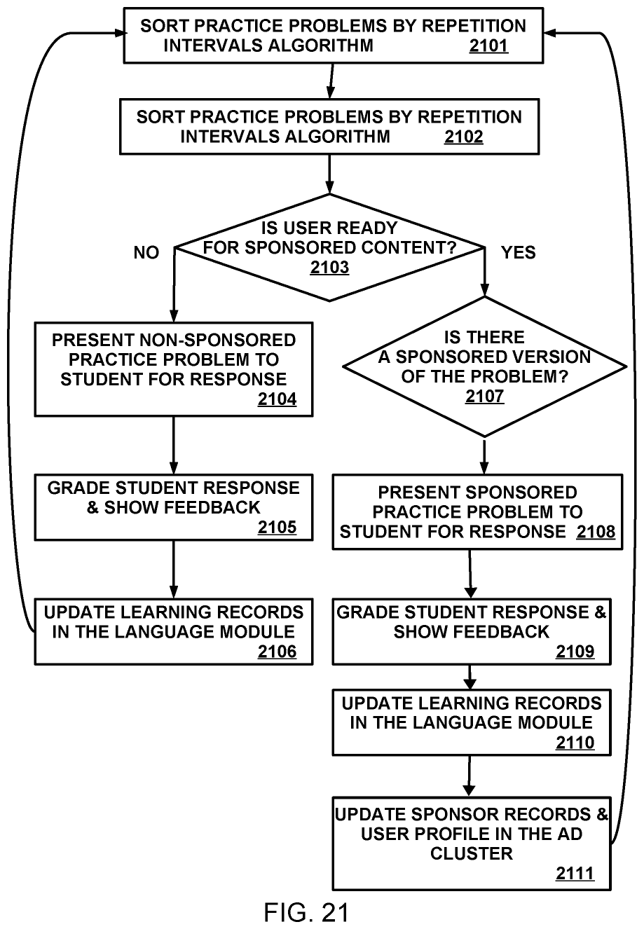

FIG. 21 is a variant of the flowchart of FIG. 20, indicating an alternate method of selecting, presenting and showing feedback for a sponsored practice problem according to the invention. In this method of selecting a sponsored practice problem, practice problems are selected according to repetition intervals first and timing of sponsored content second, such that intervals for presenting sponsored content can be pushed forward until a sponsored practice problem falling within the repetition interval is available.

In step 2101, the system sorts the practice problems in its database according to repetition intervals as determined by its spaced repetition algorithm. In step 2102 a practice problem for which the repetition interval has passed is selected.

Next 2103, the system determines whether the user is ready to see sponsored content. If sponsored content is not appropriate at this point, the system proceeds to present the practice problem for response 2104, assess the response and show feedback 2105 and update learning records for the practice problem 2106.

If, however, step 2103 determines it is now appropriate to show sponsored content, the system checks whether a sponsored practice problem based on the selected non-sponsored practice problem is available in step 2107. If a sponsored version is not available, the system proceeds with the non-sponsored version 2104. If, however, a related sponsored practice sentence exists, the system proceeds to present the sponsored practice problem for response 2108, assess the response and show feedback 2109, update learning records for the sponsored practice problem 2110 and update the learning records for the sponsored practice problem 2111.

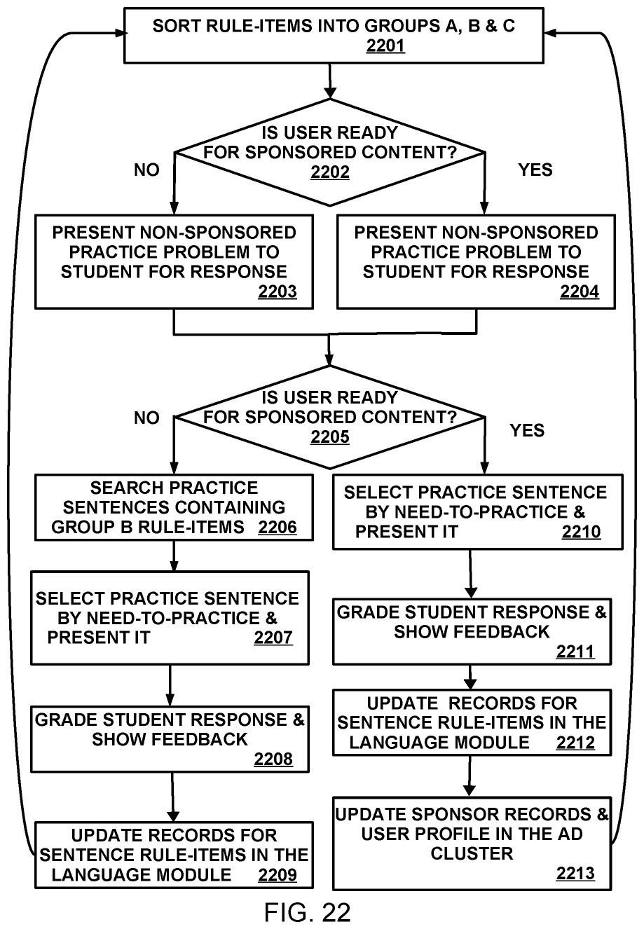

FIG. 22 is a flowchart indicating an alternate method of selecting, presenting and showing feedback for a sponsored practice problem according to the invention. This method illustrates one way of determining selection of sponsored and non-sponsored sentences when using a more sophisticated language learning system. In this example, selection occurs in a system which accounts for nuanced repetition intervals and tracks student learning using practice sentences constructed of word rule-items and sentence-governing rule-items, and language-specific aspects of those rule items.

In an example of such a more sophisticated system, each rule-item is sorted into one of three groups. Group A rule-items are known and in need of practice, meaning the student has been presented with this word or rule at least once before by the language learning system, and a need-to-practice of the rule-item is greater than zero. Such rule-items may acquire a positive need-to-practice due to the difficulty of the rule-item, the student having given incorrect answers to the rule-item previously, a number of iterations having passed since student has seen the rule-item, a period of time having passed since the student has seen the rule-item, or a combination of said factors.

Group B rule-items are known but not in need of practice, having acquired a negative need-to-practice due to receiving recent practice or correct responses by the student. Group C rule-items are unknown to the student, having never been presented by the language learning system. Group C rule-items start with a need-to-practice of 0.

In the first step 2201, the system sorts the rule-items in its database into Group A, Group Band Group C. Next 2202, the system determines whether the user is ready to see sponsored content. This determination depends on whether the user is using a paid version or advertising supported access to the system, how much time has elapsed since the user last saw sponsored content and how many practice problems (or word problems) the user has seen since last being presented with sponsored versions.

If the outcome of step 2202 is that the user is not to see sponsored content, step 2203 proceeds to the selection of non-sponsored learning content, selecting only non-sponsored practice sentences for the remaining steps. Sentences containing no Group C rule-items and at least one Group A rule-item are sought. However, if the user is to be presented sponsored content, the next step 2204 is for the system to search its database for sponsored practice sentences containing no Group C rule-items and at least one Group A rule-item.

If no practice sentence meeting the criteria in either step 2203 or 2204, respectively, is found 2205, the system proceeds to select, from its respective set of either non-sponsored or sponsored practice sentences, those containing Group Brule-items 2206, select one by need-to-practice 2207 and present it to the user. Alternatively, a Group C rule-item can be taught so that step 2204 can then proceed. The student's learning records are updated 2209. If the sentence was a sponsored one, sponsor records will also be updated in step 2209.

Alternatively, if any of the set of practice sentences are found containing known rule-items needing practice 1705, one is selected by need-to-practice 2210 and presented to the user. The student's response is evaluated and given feedback 2211, and the learning records for all rule-items in the sponsored practice problem are updated 2212. If the sentence was a sponsored one, sponsor records will also be updated in step 2212.

Where a language learning system is uncategorized according to the methods described up to this point, or where the sponsor does not wish to categorize advertising according to the methods of the language learning system, adaptive in-line sponsoring will determine need-to-practice for an ad by transcribing what words are in an ad and comparing how many of the words the student knows. Where the student knows a first pre-determined number of words in an ad, it can be played as sponsored learning content. Where a student knows a second, lower pre-determined number of words for the ad, the system can, using its teaching methods, teach enough individual words to bring the student up to the first pre-determined number of words such that the ad is deemed playable.

This transcribed ad is then presented, for example, as text, image, audio or video. The student can then be given follow-up questions attached to the sponsor's ad in which the student is asked to respond to grammar problems from the ad material or is asked to show comprehension by answering questions about the ad content. In this way, ad content not otherwise built according to the methods of the system or not otherwise categorized can be presented as effective content both for language learning and brand advertising.

In another aspect of the invention, interface sections for purchasing and creating a sponsored rule-item can allow the advertiser to pay to keep a need-to-practice value of the new sponsored practice problem at a higher value, such that its presentations to students will occur with less time elapsed between showings for each student.

In another aspect of the invention, advertiser's may pay to include links in the sponsored practice problem to coupons, videos, or other content. Student responses to such links are tracked in sponsor records.

Note that the described embodiments are not the only possible presentations of the language learning system. Also note that any database-type tables depicted are for illustrative purposes, and do not purport to accurately depict actual database tables used by the system of the invention.

The indicated student responses are not necessarily limited to typing or recorded speech; other inputs, such as OCR or writing stylus are contemplated. Similarly, large data object types are not necessarily limited to image, audio and video; language instruction, practice and sponsoring or advertising can also make use of new media such as 3-dimensional, VR, Oculus or “meta” media.

In some embodiments, paid users will have the option to have sponsored material included in language learning. In another embodiment, paid users will see sponsored material less frequently than unpaid users.

In some embodiments, the language learning system will disregard how recently a student has seen sponsored material and will simply present a sponsored problem if it contains material the student is most due to review.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A network, hardware architecture and system of presenting to a student sponsored portions of a course of language study, comprising:
at least one non-volatile data store storing information regarding a plurality of language practice problems, said non-volatile data store being part of a language text data server; and
one or more processors in communication with the at least one non-volatile data store either as part of the language text data server, or else over a network as part of a separate network server device,
said one or more processors being connected to one or more non-volatile memories storing computer-executable instructions,
said stored computer-executable instructions causing, when executed by the one or more processors, the one or more processors to execute in a network the steps of:
adding a non-sponsored translatable practice problem to a computer database of practice problems of a language learning system, said non-sponsored practice problem having at least one item of associated language learning data and having at least one associated translation response aspect;
adding a sponsored translatable practice problem to a computer database of practice problems of a language learning system, said sponsored practice problem having at least one item of associated language learning data, having at least one item of associated sponsor data, and having at least one associated translation response aspect;
selecting, from said computer database of practice problems, a non-sponsored practice problem using at least one item of associated language learning data,
presenting said selected non-sponsored practice problem for student translation;
receiving a student translation of the presented non-sponsored practice problem;
assessing the correctness of said received student translation of the presented non-sponsored practice problem via comparison with at least one translation response aspect associated with said presented non-sponsored practice problem;
updating at least one item of language learning data associated with said presented non-sponsored practice problem;
selecting, from a computer database of practice problems, a sponsored practice problem using at least one item of associated language learning data,
presenting said selected sponsored practice problem for student translation;
receiving a student translation of the presented sponsored practice problem;
assessing the correctness of said received student translation of the presented sponsored practice problem via comparison with at least one translation response aspect associated with said presented non-sponsored practice problem;
updating at least one item of language learning data associated with said presented non-sponsored practice problem; and,
updating at least one item of sponsor data associated with said presented sponsored practice problem;
wherein at least one non-sponsored practice problem is presented for student translation on a learner machine; and,
wherein at least one translation response aspect is stored on said language text data server and served to said learner machine over a network.

2. The network, hardware architecture and system of claim 1,
wherein said non-sponsored translatable practice problem is presented in the form of text, audio, video or image;
wherein said student translation of the presented non-sponsored practice problem is in the form of a typed response, a recorded spoken response or a multiple choice selection;
wherein said sponsored translatable practice problem is presented in the form of text, audio, video or image; and,
wherein said student translation of the presented sponsored practice problem is in the form of a typed response, a spoken response or a multiple choice selection.

3. The network, hardware architecture and system of claim 1,
wherein at least one item of language learning data associated with said sponsored translatable practice problem tracks one of:
how many times said sponsored translatable practice problem has been seen;
how recently said sponsored translatable practice problem was seen;
how many times said sponsored translatable practice problem has been responded to correctly;
the difficulty of said sponsored translatable practice problem; or
a repetition interval.

4. The network, hardware architecture and system of claim 1,
wherein at least one item of sponsor data associated with said sponsored translatable practice problem tracks one of:
number of users that have seen the sponsored translatable practice problem;
number of times the sponsored translatable practice problem has been presented;
number of users that have seen the sponsored translatable practice problem in a particular time period; or,
number of times the sponsored translatable practice problem has been presented in a particular time period.

5. The network, hardware architecture and system of claim 1,
wherein said non-sponsored translatable practice problem also has at least one item of associated sponsoring data,
wherein said sponsored translatable practice problem also has at least one item of associated sponsoring data, and further including the steps of:
updating at least one item of sponsoring data associated with said presented sponsored practice problem.

6. The network, hardware architecture and system of claim 1,
wherein said sponsored practice problem is in the form of an arithmetic word problem; and,
wherein said step of receiving a student translation of the presented sponsored practice problem is instead a step of receiving a student solution of said arithmetic word problem.

7. The network, hardware architecture and system of claim 1,
wherein said non-sponsored practice problem comprises a set of language rule-items, each of said language rule-items having at least one associated language learning record.

8. The network, hardware architecture and system of claim 1,
further including the step of:
selecting, from said computer database of practice problems, a sponsored practice problem using at least one item of associated sponsor data.

9. The network, hardware architecture and system of claim 1,
said presented sponsored practice problem having at least one item of sponsoring data, and further including the step of
updating at least one item of sponsoring data associated with said presented sponsored practice problem.

10. The network, hardware architecture and system of claim 1,
further comprising the steps of:
receiving from a sponsor a request to add a new sponsored translatable practice problem to the language learning system, said new sponsored translatable practice problem comprising a sponsor trademark, brand, product name or branding message;
adding said new sponsored translatable practice problem to the computer database of practice problems of the language learning system;
associating said new sponsored translatable practice problem with at least one item of language learning data;
associating said new sponsored translatable practice problem with at least one translation response aspect; and,
associating said new sponsored translatable practice problem with at least one item of sponsor data.

11. The network, hardware architecture and system of claim 1,
further comprising the steps of:
designating a non-sponsored translatable practice problem in the computer database of practice problems of the language learning system to be a first sponsorable practice problem;
designating a first word in said first sponsorable practice problem to be editable;
receiving a login of a sponsor account user to said language learning system;
presenting, to said sponsor account user, said first sponsorable practice problem;
detecting a selection of the presented first sponsorable practice problem by said sponsor account user;
presenting, to said sponsor account user, an interface with which to edit the designated first editable word of said first sponsorable practice problem;
receiving an edit of said designated first editable word of said first sponsorable practice problem;
creating a first new translatable practice problem based on said designated first sponsorable practice problem and incorporating said received edit of said designated first editable word; and,
storing said first new translatable practice problem as a first new sponsored translatable practice problem.
adding said first new sponsored translatable practice problem to the computer database of practice problems of the language learning system;
associating said first new sponsored translatable practice problem with at least one item of language learning data;
associating said first new sponsored translatable practice problem with at least one translation response aspect; and,
associating said first new sponsored translatable practice problem with at least one item of sponsor data.

12. The network, hardware architecture and system of claim 1,
wherein said language text data server is part of a language learning hardware cluster, and
wherein at least one component of said language learning hardware cluster is a database server having at least one aspect optimized for efficient network and hardware performance in regard to text search results.

13. The network, hardware architecture and system of claim 1,
wherein said selected sponsored practice problem is presented for student translation on a learner machine with an in-line audio, video, image, VR or other media file;
wherein said in-line audio, video, image, VR or other media file is stored in an ad hardware cluster and served to said learner machine over a network; and,
wherein at least one component of said ad hardware cluster is a database server having at least one aspect optimized for efficient network and hardware performance in regard to binary large object files.

14. The network, hardware architecture and system of claim 1,
wherein said language text data server is part of a language learning hardware cluster;
wherein at least one component of said language learning hardware cluster is a database server having at least one aspect optimized for efficient network and hardware performance in regard to text search results;
wherein said selected sponsored practice problem is presented for student translation on a learner machine with an in-line audio, video, image, VR or other media file;
wherein said in-line audio, video, image or VR file is stored in an ad hardware cluster and served to said learner machine over a network; and,
wherein at least one component of said ad hardware cluster is a database server having at least one aspect optimized for efficient network and hardware performance in regard to binary large object files.

15. A network, hardware device arrangement and system of adding a sponsored translatable practice problems to a computer database of practice problems of a language learning system, comprising:
at least one non-volatile data store including information regarding a plurality of language practice problems, said non-volatile data store being part of a language text data server; and
one or more processors in communication with the at least one non-volatile data store either as part of the language text data server, or else over a network as part of a separate network server device,
said one or more processors being connected to one or more non-volatile memories storing computer-executable instructions,
said stored computer-executable instructions causing, when executed by the one or more processors, the one or more processors to execute in a network the steps of:
receiving from a sponsor a request to add a new sponsored translatable practice problem to the language learning system, said new sponsored translatable practice problem comprising a sponsor trademark, brand, product name, branding message or brand media file;
adding said new sponsored translatable practice problem to a computer database of practice problems of the language learning system;
associating said new sponsored translatable practice problem with at least one item of language learning data;
associating said new sponsored translatable practice problem with at least one translation response aspect; and,
associating said new sponsored translatable practice problem with at least one item of sponsor data.

16. The network, hardware device arrangement and system of claim 15, further comprising the steps of:
designating a non-sponsored translatable practice problem in a computer database of practice problems of the language learning system to be a first sponsorable practice problem;
designating a first word in said first sponsorable practice problem to be editable;
receiving a login of a sponsor account user to said language learning system;
presenting said first sponsorable practice problem to said sponsor account user on an ad buyer machine;
detecting a selection of the presented first sponsorable practice problem by said sponsor account user;
presenting, to said sponsor account user, an interface with which to edit the designated first editable word of said first sponsorable practice problem;
receiving, from said ad buyer machine, over a network, an edit of said designated first editable word of said first sponsorable practice problem;
creating a first new translatable practice problem based on said designated first sponsorable practice problem and incorporating said received edit of said designated first editable word; and,
storing said first new translatable practice problem as a first new sponsored translatable practice problem in a computer database of practice problems of the language learning system.

17. The network, hardware device arrangement and system of claim 15, further comprising the steps of:
presenting a sponsor functions display, said sponsor functions display including sponsoring data.

18. The network, hardware device arrangement and system of claim 15,
wherein said language text data server is part of a language learning hardware cluster;
and, wherein at least one component of said language learning hardware cluster is a database server having at least one aspect optimized for efficient network and hardware performance in regard to text search results.

19. The network, hardware device arrangement and system of claim 15,
wherein said sponsored practice problem is presented for student translation on a learner machine with an in-line audio, video, image, VR or other media file;
wherein said in-line audio, video, image, VR or other media file is stored in an ad hardware cluster and served to said learner machine over a network; and,
wherein at least one component of said ad hardware cluster is a database server having at least one aspect optimized for efficient network and hardware performance in regard to binary large object files.

20. The network, hardware device arrangement and system of claim 15,
wherein said language text data server is part of a language learning hardware cluster;
wherein at least one component of said language learning hardware cluster is a database server having at least one aspect optimized for efficient network and hardware performance in regard to text search results;
wherein said selected sponsored practice problem is presented for student translation on a learner machine with an in-line audio, video, image, VR or other media file;
wherein said in-line audio, video, image or VR file is stored in an ad hardware cluster and served to said learner machine over a network; and,
wherein at least one component of said ad hardware cluster is a database server having at least one aspect optimized for efficient network and hardware performance in regard to binary large object files.

21. The network, hardware device arrangement and system of claim 15, further comprising the step of:
determining a presentation order for at least some of the translatable practice problems in the computer database of practice problems of the language learning system.

22. The network, hardware device arrangement and system of claim 15, further comprising the steps of:
determining a presentation order for at least some of the translatable practice problems in the computer database of practice problems of the language learning system; and,
determining whether a current user of the language learning system is to be presented a sponsored translatable practice problem on a learner machine.

23. A network, hardware device arrangement and system of presenting to a student sponsored portions of a course of language study, comprising the steps of:
adding a non-sponsored translatable practice problem to a computer database of practice problems of a language learning system, said non-sponsored practice problem having at least one item of associated language learning data and having at least one associated translation response aspect;
receiving from a sponsor a request to add a new sponsored translatable practice problem to the language learning system, said new sponsored translatable practice problem comprising a sponsor trademark, brand, product name or branding message;
adding said new sponsored translatable practice problem to the computer database of practice problems of the language learning system;
associating said new sponsored translatable practice problem with at least one item of language learning data;
associating said new sponsored translatable practice problem with at least one translation response aspect; and,
associating said new sponsored translatable practice problem with at least one item of sponsor data.
determining a presentation order for at least some of the translatable practice problems in the computer database of practice problems of the language learning system;
determining whether a current user of the language learning system is to be presented a sponsored translatable practice problem;
selecting, from said computer database of practice problems, a non-sponsored practice problem using at least one item of associated language learning data,
presenting said selected non-sponsored practice problem for student translation;
receiving a student translation of the presented non-sponsored practice problem;
assessing the correctness of said received student translation of the presented non-sponsored practice problem via comparison with at least one translation response aspect associated with said presented non-sponsored practice problem;
updating at least one item of language learning data associated with said presented non-sponsored practice problem;
selecting, from said computer database of practice problems, a sponsored practice problem using at least one item of associated language learning data,
presenting said selected sponsored practice problem for student translation;
receiving a student translation of the presented sponsored practice problem;
assessing the correctness of said received student translation of the presented sponsored practice problem via comparison with at least one translation response aspect associated with said presented sponsored practice problem;
updating at least one item of language learning data associated with said presented sponsored practice problem;
and,
updating at least one item of sponsor data associated with said presented sponsored practice problem.

24. The network, hardware device arrangement and system of claim 23, further comprising the steps of:
designating a non-sponsored translatable practice problem in the computer database of practice problems of the language learning system to be a first sponsorable practice problem;
designating a first word in said first sponsorable practice problem to be editable;
receiving a login of a sponsor account user to said language learning system;
presenting, to said sponsor account user, said first sponsorable practice problem;
detecting a selection of the presented first sponsorable practice problem by said sponsor account user;
presenting, to said sponsor account user, an interface with which to edit the designated first editable word of said first sponsorable practice problem;
receiving an edit of said designated first editable word of said first sponsorable practice problem;
creating a first new translatable practice problem based on said designated first sponsorable practice problem and incorporating said received edit of said designated first editable word; and,
storing said first new translatable practice problem as a first new sponsored translatable practice problem.

25. The network, hardware device arrangement and system of claim 23, further comprising the steps of:
presenting a sponsor functions display, said sponsor functions display including sponsoring data.

26. The network, hardware device arrangement and system of claim 23,
wherein said non-sponsored practice problem comprises a set of language rule-items, each of said language rule-items having at least one associated language learning record.
